(19) United States
(12) Patent Application Publication
(10) Pub. No.: US 2024/0378877 A1
(43) Pub. Date: Nov. 14, 2024

(54) IMAGING DEVICE, IMAGING METHOD, AND IMAGING PROGRAM

(71) Applicant: Sony Semiconductor Solutions Corporation, Atsugi-shi, Kanagawa (JP)

(72) Inventor: Hiroaki NISHIYA, Kanagawa (JP)

(73) Assignee: Sony Semiconductor Solutions Corporation, Atsugi-shi, Kanagawa (JP)

(21) Appl. No.: 18/564,631

(22) PCT Filed: Jun. 3, 2022
(86) PCT No.: PCT/JP2022/022684

§ 371 Date: Nov. 28, 2023

(30) Foreign Application Priority Data
Jun. 4, 2021 (JP) 2021-094494

(51) Int. Cl. G06V 10/82; G06N 3/045; G06N 3/0464; G06V 10/10

(52) U.S. Cl. CPC G06V 10/82; G06N 3/045; G06N 3/0464; G06V 10/10

(57) ABSTRACT

A memory region is suppressed. An imaging device according to the present disclosure includes: a sensor that outputs first image data; a first processing unit that executes processing of a first layer in a neural network having a layered structure on the first image data in units of second image data having a size smaller than an entire size of the first image data; and a second processing unit that executes processing of a second layer in the neural network on a processing result output from the first processing unit.

### FIELD

The present disclosure relates to an imaging device, an imaging method, and an imaging program.

### BACKGROUND

In recent years, with increases in performance of imaging devices such as digital still cameras, digital video cameras, and small cameras mounted on multifunctional mobile phones (smartphones) and the like, imaging devices equipped with an image recognition function of recognizing a predetermined object included in a captured image have been developed.

### CITATION LIST

### Patent Literature

Patent Literature 1: Japanese Patent Application Laid-open No. 10-247241

### SUMMARY

### Technical Problem

However, conventionally, there is a problem that an increase in processing time and a decrease in an available memory region occur in order to execute an image recognition function.

An object of the present disclosure is to provide an imaging device, an imaging method, and an imaging program capable of suppressing a memory region.

### Solution to Problem

An imaging device according to the present disclosure includes: a sensor that outputs first image data; a first processing unit that executes processing of a first layer in a neural network having a layered structure on the first image data in units of second image data having a size smaller than an entire size of the first image data; and a second processing unit that executes processing of a second layer in the neural network on a processing result output from the first processing unit.

### BRIEF DESCRIPTION OF DRAWINGS

FIG. 1 is a block diagram illustrating a configuration of an example of an imaging device applicable to a first embodiment of the present disclosure.

FIG. 2A is a diagram illustrating an example in which the imaging device according to the first embodiment is formed by a stacked CIS having a two-layer structure.

FIG. 2B is a diagram illustrating an example in which the imaging device according to the first embodiment is formed by a stacked CIS having a three-layer structure.

FIG. 3 is a block diagram illustrating a configuration of an example of a sensor 11 applicable to the first embodiment.

FIG. 4A is a schematic diagram for explaining a rolling shutter system.

FIG. 4B is a schematic diagram for explaining the rolling shutter system.

FIG. 4C is a schematic diagram for explaining the rolling shutter system.

FIG. 5A is a schematic diagram for explaining line thinning in the rolling shutter system.

FIG. 5B is a schematic diagram for explaining the line thinning in the rolling shutter system.

FIG. 5C is a schematic diagram for explaining the line thinning in the rolling shutter system.

FIG. 6A is a diagram schematically illustrating an example of another imaging method in the rolling shutter system.

FIG. 6B is a diagram schematically illustrating an example of another imaging method in the rolling shutter system.

FIG. 7A is a schematic diagram for explaining a global shutter system.

FIG. 7B is a schematic diagram for explaining the global shutter system.

FIG. 7C is a schematic diagram for explaining the global shutter system.

FIG. 8A is a diagram schematically illustrating an example of a sampling pattern that can be implemented in the global shutter system.

FIG. 8B is a diagram schematically illustrating an example of the sampling pattern that can be implemented in the global shutter system.

FIG. 9 is a diagram schematically illustrating image recognition processing by a CNN.

FIG. 10 is a diagram schematically illustrating image recognition processing of obtaining a recognition result from a part of an image to be recognized.

FIG. 11A is a diagram for explaining a relationship between a driving speed of a frame and an amount of a read pixel signal.

FIG. 11B is a diagram for explaining a relationship between a driving speed of a frame and an amount of a read pixel signal.

FIG. 12 is a diagram illustrating an example of processing time of a conventional image recognition function.

FIG. 13 is a diagram illustrating an example of a memory region necessary for the conventional image recognition function.

FIG. 14 is a diagram illustrating an example of processing time of an image recognition function according to the first embodiment.

FIG. 15 is a diagram illustrating an example of a memory region necessary for the image recognition function according to the first embodiment.

FIG. 16A is a diagram illustrating an example of convolution processing and MaxPooling processing according to the first embodiment.

FIG. 16B is a diagram illustrating the example of the convolution processing and MaxPooling processing according to the first embodiment.

FIG. 16C is a diagram illustrating the example of the convolution processing and MaxPooling processing according to the first embodiment.

FIG. 16D is a diagram illustrating the example of the convolution processing and MaxPooling processing according to the first embodiment.

FIG. 16E is a diagram illustrating the example of the convolution processing and MaxPooling processing according to the first embodiment.

FIG. 16F is a diagram illustrating the example of the convolution processing and MaxPooling processing according to the first embodiment.

FIG. 16G is a diagram illustrating the example of the convolution processing and MaxPooling processing according to the first embodiment.

FIG. 16H is a diagram illustrating the example of the convolution processing and MaxPooling processing according to the first embodiment.

FIG. 16I is a diagram illustrating the example of the convolution processing and MaxPooling processing according to the first embodiment.

FIG. 16J is a diagram illustrating the example of the convolution processing and MaxPooling processing according to the first embodiment.

FIG. 16K is a diagram illustrating the example of the convolution processing and MaxPooling processing according to the first embodiment.

FIG. 16L is a diagram illustrating the example of the convolution processing and MaxPooling processing according to the first embodiment.

FIG. 17 is a diagram illustrating a decomposition example (in the case of units of convolution) of processing in the first embodiment.

FIG. 18 is a diagram illustrating Example 1 of the processing in the first embodiment.

FIG. 19 is a diagram illustrating Example 2 of the processing in the first embodiment.

FIG. 20 is a diagram illustrating Example 3 of the processing in the first embodiment.

FIG. 21 is a block diagram illustrating a configuration of an example of an imaging device applicable to a second embodiment.

FIG. 22 is a diagram illustrating a decomposition example (in the case of units of one line) of processing in the second embodiment.

FIG. 23 is a diagram illustrating Example 1 of the processing in the second embodiment.

FIG. 24 is a diagram illustrating Example 2 of the processing in the second embodiment.

FIG. 25 is a diagram illustrating Example 3 of the processing in the second embodiment.

FIG. 26 is a diagram for explaining Example 1 of effects of the first and second embodiments.

FIG. 27 is a diagram for explaining Example 2 of effects of the first and second embodiments.

FIG. 28 is a diagram illustrating an example of a processing structure to which the technology according to the present disclosure can be applied.

FIG. 29 is a diagram illustrating another example of the processing structure to which the technology according to the present disclosure can be applied.

FIG. 30 is a diagram for explaining processing according to a first example of a fourth embodiment.

FIG. 31 is a diagram for explaining processing according to a second example of the fourth embodiment.

FIG. 32 is a diagram for explaining an outline of deconvolution processing.

FIG. 33 is a diagram for explaining deconvolution processing according to a third example of the fourth embodiment.

FIG. 34 is a diagram for explaining an operation of an auto encoder implemented by an AI processing unit in a fourth example of the fourth embodiment (first stage).

FIG. 35 is a diagram for explaining the operation of the auto encoder implemented by the AI processing unit in the fourth example of the fourth embodiment (second stage).

FIG. 36 is a diagram for explaining the operation of the auto encoder implemented by the AI processing unit in the fourth example of the fourth embodiment (third stage).

FIG. 37 is a diagram for explaining the operation of the auto encoder implemented by the AI processing unit in the fourth example of the fourth embodiment (third stage).

FIG. 38 is a diagram for explaining the operation of the auto encoder implemented by the AI processing unit in the fourth example of the fourth embodiment (fifth stage).

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

Hereinafter, the embodiments of the present disclosure will be described in the following order.
1. Example of Configuration According to First Embodiment of Present Disclosure
2. Example of Technology Applicable to Present Disclosure
2-1. Outline of Rolling Shutter
2-2. Outline of Global Shutter
2-3. Regarding Deep Neural Network (DNN)
2-3-1. Overview of Convolutional Neural Network (CNN)
2-4. Regarding Driving Speed
3. Summary of Present Disclosure
3-1. First Embodiment
3-2. Second Embodiment
3-3. Example of Effects of First and Second Embodiments
3-4. Third Embodiment
3-5. Fourth Embodiment

### 1. Example of Configuration According to First Embodiment of Present Disclosure

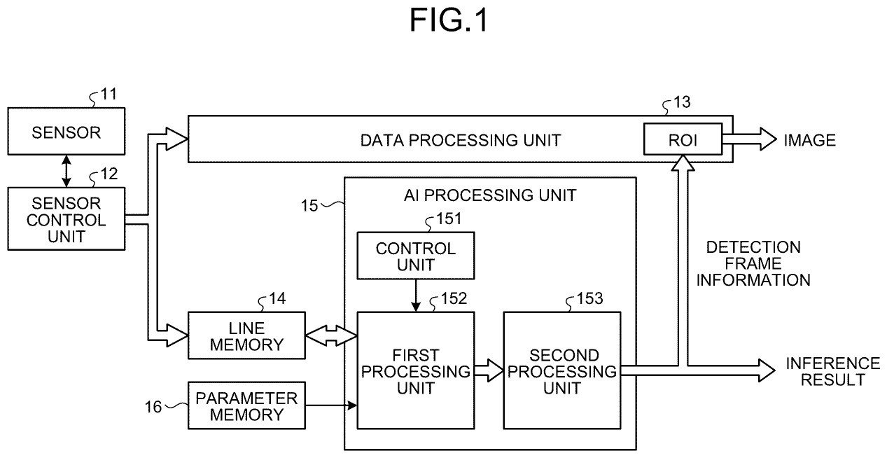

A configuration of an imaging device according to the present disclosure will be schematically described. FIG. 1 is a block diagram illustrating a configuration of an example of an imaging device applicable to a first embodiment of the present disclosure. In FIG. 1, an imaging device 1 includes a sensor 11, a sensor control unit 12, a data processing unit 13, a line memory 14, an artificial intelligence (AI) processing unit 15, and a parameter memory 16, and is a complementary metal oxide semiconductor (CMOS) image sensor (CIS) in which these units are integrally formed using a CMOS. Note that the imaging device 1 is not limited to this example, and may be another type of optical sensor such as an infrared light sensor that performs imaging with infrared light.

The sensor 11 outputs a pixel signal corresponding to light with which a light receiving surface was irradiated. More specifically, the sensor 11 has a pixel array in which pixels including at least one photoelectric conversion element are arranged in a matrix. The light receiving surface is formed by each of the pixels arranged in the matrix in the pixel array. The sensor 11 further includes a drive circuit for driving each of the pixels included in the pixel array, and a signal processing circuit that performs predetermined signal processing on a signal read from each of the pixels and outputs the signal as a pixel signal of each of the pixels. The sensor 11 outputs the pixel signal of each of the pixels included in a pixel region as digital image data.

Hereinafter, a region that is included in the pixel array included in the sensor 11 and in which valid pixels for generating a pixel signal are arranged is referred to as a frame. The sensor 11 captures an image for one frame by the pixel region in which the plurality of pixels is arranged. Specifically, frame image data is formed by pixel data based on each pixel signal output from each of the pixels included in the frame. Furthermore, each row in the array of pixels of the sensor 11 is referred to as a line, and line image data is formed by pixel data based on a pixel signal output from each of pixels included in the line. Furthermore, an operation in which the sensor 11 outputs a pixel signal corresponding to light with which the light receiving surface was irradiated is referred to as imaging. Exposure at the time of imaging by the sensor 11 and a gain (analog gain) for a pixel signal are controlled by an imaging control signal supplied from the sensor control unit 12.

The sensor control unit 12 includes, for example, a microprocessor, controls reading of pixel data from the sensor 11, and outputs pixel data based on each pixel signal read from each of the pixels included in the frame. The pixel data output from the sensor control unit 12 is passed to the data processing unit 13 and the line memory 14.

Furthermore, the sensor control unit 12 generates an imaging control signal for controlling imaging in the sensor 11. The sensor control unit 12 generates an imaging control signal. The imaging control signal includes information indicating the above-described exposure and analog gain at the time of imaging in the sensor 11. The imaging control signal further includes a control signal (a vertical synchronization signal, a horizontal synchronization signal, and the like) to be used by the sensor 11 to perform an imaging operation. The sensor control unit 12 supplies the generated imaging control signal to the sensor 11.

Upon receiving the pixel data read by the sensor control unit 12, the data processing unit 13 executes data processing on the pixel data and outputs an image. For example, upon receiving detection frame information from a second processing unit 153 of the AI processing unit 15, the data processing unit 13 outputs an image in which a region of interest (ROI) is specified by the detection frame information.

The line memory 14 holds data to be input to a first processing unit 152 of the AI processing unit 15 in a predetermined line unit. The predetermined line unit is, for example, a line unit corresponding to the number of rows of a filter (kernel) used for convolution processing. Specifically, for example, in the case of convolution processing using a filter of a 3×3 size, the line memory 14 holds pixels for three lines read from the pixel region as data of an execution unit of the convolution processing. For example, the line memory 14 stores pixels of lines corresponding to the number of rows of the filter in order from a readout start position of the pixel region, and pixels of a line of the pixel region processed (used) by the first processing unit 152 are updated with the pixels of the lines newly read from the pixel region, whereby the line memory 14 stores (updates) the data of the execution unit of the convolution processing.

The AI processing unit 15 includes a control unit 151, the first processing unit 152, and the second processing unit 153.

The control unit 151 controls an operation of the first processing unit 152. The control unit 151 performs, for example, start control of the convolution processing and feature amount extraction processing by the first processing unit 152. For example, the control unit 151 controls the operation of the first processing unit 152 so as to execute the convolution processing each time data of the execution unit of the convolution processing is stored in the line memory 14.

The first processing unit 152 executes the convolution processing not in units of images for one frame but in the predetermined line unit read from the pixel region of the sensor 11, and executes the feature amount extraction processing based on a result of executing the convolution processing. Note that the feature amount extraction processing may be arbitrary. The feature amount extraction processing is, for example, MaxPooling processing, average pooling processing, or the like. In the first embodiment, a case where the feature amount extraction processing is MaxPooling processing will be described as an example.

The second processing unit 153 executes full-connection processing based on a result of the feature amount extraction processing by the first processing unit 152, and outputs an inference result (image recognition result) based on a result of the full-connection processing.

The parameter memory 16 stores parameters used for processing executed by the AI processing unit 15.

Each processing unit that executes the above-described processing in the imaging device 1 is implemented by, for example, a circuit. In a case where the imaging device 1 is implemented by a circuit, for example, the imaging device 1 can be formed on a single substrate. Furthermore, for example, the imaging device 1 may be a stacked CIS in which a plurality of semiconductor chips is stacked and integrally formed.

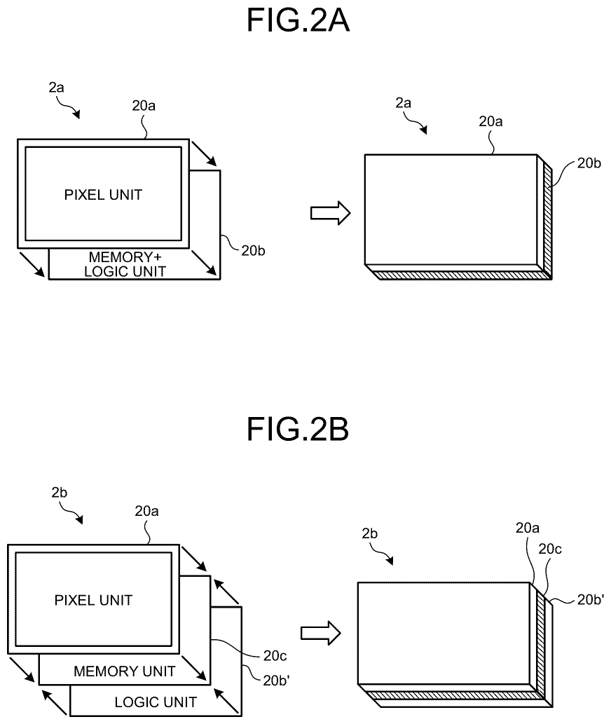

As an example, the imaging device 1 can be formed to have a two-layer structure in which semiconductor chips are stacked in two layers. FIG. 2A is a diagram illustrating an example in which the imaging device 1 according to the first embodiment is formed by a stacked CIS having a two-layer structure. In the structure illustrated in FIG. 2A, a pixel unit 20a is formed on the semiconductor chip of the first layer, and a memory+logic unit 20b is formed on the semiconductor chip of the second layer. The pixel unit 20a includes at least the pixel array in the sensor 11. The memory+logic unit 20b includes, for example, the sensor control unit 12, the data processing unit 13, the line memory 14, the AI processing unit 15, the parameter memory 16, and an interface for performing communication between the imaging device 1 and the outside. The memory+logic unit 20b further includes a part or all of the drive circuit that drives the pixel array in the sensor 11.

As illustrated on the right side of FIG. 2A, the imaging device 1 is configured as one solid-state imaging element (image sensor) 2a by bonding the semiconductor chip of the first layer and the semiconductor chip of the second layer while electrically contacting each other.

As another example, the imaging device 1 can be formed to have a three-layer structure in which semiconductor chips are stacked in three layers. FIG. 2B is a diagram illustrating an example in which the imaging device 1 according to the first embodiment is formed by a stacked CIS having a three-layer structure. In the structure illustrated in FIG. 2B, a pixel unit 20a is formed on the semiconductor chip of the first layer, a memory unit 20c is formed on the semiconductor chip of the second layer, and a logic unit 20b′ is formed on the semiconductor chip of the third layer. In this case, the logic unit 20b′ includes, for example, the data processing unit 13, the line memory 14, the AI processing unit 15, the parameter memory 16, and an interface for performing communication between the imaging device 1 and the outside.

As illustrated on the right side of FIG. 2B, the imaging device 1 is configured as one solid-state imaging element 2b by bonding the semiconductor chip of the first layer, the semiconductor chip of the second layer, and the semiconductor chip of the third layer while electrically contacting each other.

Note that a part of each processing unit of the imaging device 1 illustrated in FIG. 1 may be implemented by software (a program). For example, the AI processing unit 15 may be implemented by causing a processor such as a central processing unit (CPU) to execute the program.

The program that is executed by the imaging device 1 according to the embodiment is recorded in a computer-readable storage medium such as a CD-ROM, a memory card, a CD-R, and a DVD as a file in an installable format or an executable format, and is provided as a computer program product.

Furthermore, the program that is executed by the imaging device 1 according to the embodiment may be stored on a computer connected to a network such as the Internet and provided by being downloaded via the network. In addition, the program that is executed by the imaging device 1 according to the embodiment may be provided via a network such as the Internet without being downloaded.

In addition, the program of the imaging device 1 according to the embodiment may be provided by being incorporated in a ROM or the like in advance.

In addition, in a case where each processing unit is implemented by using a plurality of processors, each processor may implement a single processing unit or may implement a plurality of processing units.

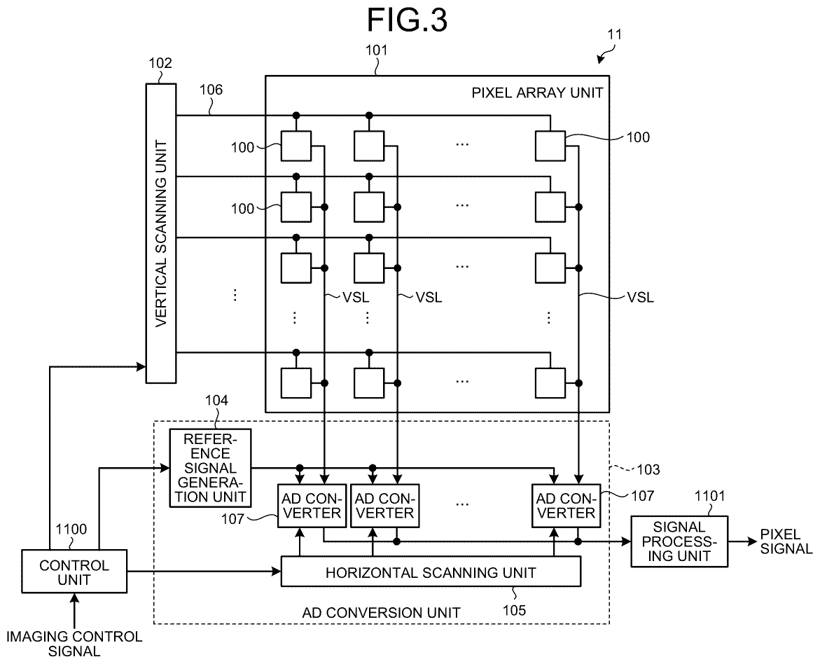

FIG. 3 is a block diagram illustrating a configuration of an example of the sensor 11 applicable to the first embodiment. In FIG. 3, the sensor 11 includes a pixel array unit 101, a vertical scanning unit 102, an analog to digital (AD) conversion unit 103, pixel signal lines 106, vertical signal lines VSL, a control unit 1100, and a signal processing unit 1101. Note that, in FIG. 3, the control unit 1100 and the signal processing unit 1101 can also be included in the sensor control unit 12 illustrated in FIG. 1, for example.

The pixel array unit 101 includes a plurality of pixel circuits 100 including, for example, a photoelectric conversion element that performs photoelectric conversion on received light and is formed by a photodiode, and a circuit that reads electric charges from the photoelectric conversion element. In the pixel array unit 101, the plurality of pixel circuits 100 is arranged in a matrix in a horizontal direction (row direction) and a vertical direction (column direction). In the pixel array unit 101, the arrangement of the pixel circuits 100 in the row direction is referred to as a line. For example, in a case where an image of one frame is formed with 1920 pixels×1080 lines, the sensor 11 includes at least 1080 lines including at least 1920 pixel circuits 100. An image (image data) of one frame is formed by pixel signals read from the pixel circuits 100 included in the frame.

Hereinafter, an operation of reading a pixel signal from each pixel circuit 100 included in the frame in the sensor 11 will be described as, for example, reading a pixel from the frame as appropriate. Furthermore, an operation of reading a pixel signal from each pixel circuit 100 included in a line included in the frame will be described as, for example, reading the line as appropriate.

Furthermore, in the pixel array unit 101, a pixel signal line 106 is connected to each row of each pixel circuit 100, and a vertical signal line VSL is connected to each column of each pixel circuit 100. Ends of the pixel signal lines 106 that are not connected to the sensor 11 are connected to the vertical scanning unit 102. The vertical scanning unit 102 transmits a control signal such as a drive pulse for reading pixel signals from the pixels to the pixel array unit 101 via the pixel signal lines 106 under control by the control unit 1100 described later. Ends of the vertical signal lines VSL that are not connected to the pixel array unit 101 are connected to the AD conversion unit 103. The pixel signals read from the pixels are transmitted to the AD conversion unit 103 via the vertical signal lines VSL.

The control of reading a pixel signal from a pixel circuit 100 will be schematically described. The reading of the pixel signal from the pixel circuit 100 is performed by transferring electric charges accumulated in the photoelectric conversion element by exposure to a floating diffusion layer (FD), and converting the transferred electric charges into a voltage in the floating diffusion layer. The voltage obtained by converting the electric charges in the floating diffusion layer is output to the vertical signal line VSL via an amplifier.

More specifically, in the pixel circuit 100, during the exposure, a space between the photoelectric conversion element and the floating diffusion layer is set to an off (open) state, and electric charges generated according to incident light by photoelectric conversion are accumulated in the photoelectric conversion element. After the exposure is completed, the floating diffusion layer and the vertical signal line VSL are connected according to a selection signal supplied via the pixel signal line 106. Further, according to a reset pulse supplied via the pixel signal line 106, the floating diffusion layer is connected to a supply line for a power supply voltage VDD or a black level voltage in a short period of time and is reset. A voltage (referred to as a voltage A) at a reset level of the floating diffusion layer is output to the vertical signal line VSL. Thereafter, the space between the photoelectric conversion element and the floating diffusion layer is set to an on (closed) state by a transfer pulse supplied via the pixel signal line 106, and electric charges accumulated in the photoelectric conversion element are transferred to the floating diffusion layer. A voltage (referred to as a voltage B) corresponding to the amount of electric charges of the floating diffusion layer is output to the vertical signal line VSL.

The AD conversion unit 103 includes an AD converter 107 provided for each vertical signal line VSL, a reference signal generation unit 104, and a horizontal scanning unit 105. The AD converter 107 is a column AD converter that performs AD conversion processing on each column (column) of the pixel array unit 101. The AD converter 107 performs AD conversion processing on pixel signals supplied from the pixel circuits 100 via the vertical signal line VSL, and generates two digital values (values corresponding to the voltage A and the voltage B) for correlated double sampling (CDS) processing for noise reduction.

The AD converter 107 supplies the generated two digital values to the signal processing unit 1101. The signal processing unit 1101 performs CDS processing based on the two digital values supplied from the AD converter 107, and generates a pixel signal (pixel data) by a digital signal. The pixel data generated by the signal processing unit 1101 is output to the outside of the sensor 11.

Based on a control signal input from the control unit 1100, the reference signal generation unit 104 generates, as a reference signal, a ramp signal to be used by each AD converter 107 to convert a pixel signal into two digital values. The ramp signal is a signal in which a level (voltage value) decreases at a constant rate with respect to time, or a signal in which a level decreases stepwise. The reference signal generation unit 104 supplies the generated ramp signal to each AD converter 107. The reference signal generation unit 104 includes, for example, a digital-to-analog converter (DAC) or the like.

When a ramp signal whose voltage drops stepwise according to a predetermined inclination is supplied from the reference signal generation unit 104, a counter starts counting according to a clock signal. A comparator compares a voltage of a pixel signal supplied from a vertical signal line VSL with the voltage of the ramp signal, and stops counting by the counter at a timing when the voltage of the ramp signal exceeds the voltage of the pixel signal. The AD converter 107 converts a pixel signal by an analog signal into digital values by outputting a value corresponding to a count value at the time when the counting is stopped.

The AD converter 107 supplies the generated two digital values to the signal processing unit 1101. The signal processing unit 1101 performs CDS processing based on the two digital values supplied from the AD converter 107, and generates a pixel signal (pixel data) by a digital signal. The pixel signal by the digital signal generated by the signal processing unit 1101 is output to the outside of the sensor 11.

Under control by the control unit 1100, the horizontal scanning unit 105 performs selective scanning to select each AD converter 107 in a predetermined order, thereby sequentially outputting each digital value temporarily held in each AD converter 107 to the signal processing unit 1101. The horizontal scanning unit 105 includes, for example, a shift register, an address decoder, and the like.

The control unit 1100 controls driving of the vertical scanning unit 102, the AD conversion unit 103, the reference signal generation unit 104, the horizontal scanning unit 105, and the like in accordance with an imaging control signal supplied from the sensor control unit 12. The control unit 1100 generates various drive signals serving as references for operations of the vertical scanning unit 102, the AD conversion unit 103, the reference signal generation unit 104, and the horizontal scanning unit 105. The control unit 1100 generates a control signal for the vertical scanning unit 102 to supply to each pixel circuit 100 via the pixel signal lines 106 based on, for example, a vertical synchronization signal or an external trigger signal and a horizontal synchronization signal included in the imaging control signal. The control unit 1100 supplies the generated control signal to the vertical scanning unit 102.

Furthermore, for example, the control unit 1100 passes, to the AD conversion unit 103, information indicating the analog gain and included in the imaging control signal supplied from the sensor control unit 12. The AD conversion unit 103 controls a gain of a pixel signal input to each of the AD converters 107 included in the AD conversion unit 103 via the vertical signal lines VSL according to the information indicating the analog gain.

Based on the control signal supplied from the control unit 1100, the vertical scanning unit 102 supplies various signals including the drive pulse to a pixel signal line 106 of a selected pixel row of the pixel array unit 101 to each pixel circuit 100 for each line, and causes each pixel circuit 100 to output the pixel signal to the vertical signal line VSL. The vertical scanning unit 102 includes, for example, a shift register, an address decoder, and the like. Furthermore, the vertical scanning unit 102 controls the exposure in each pixel circuit 100 according to information indicating the exposure and supplied from the control unit 1100.

The sensor unit 10 configured as described above is a column AD type complementary metal oxide semiconductor (CMOS) image sensor in which the AD converters 107 are arranged for each column.

### 2. Example of Technology Applicable to Present Disclosure

Prior to the description of the first embodiment according to the present disclosure, the technology applicable to the present disclosure will be schematically described in order to facilitate understanding.

### 2-1. Outline of Rolling Shutter

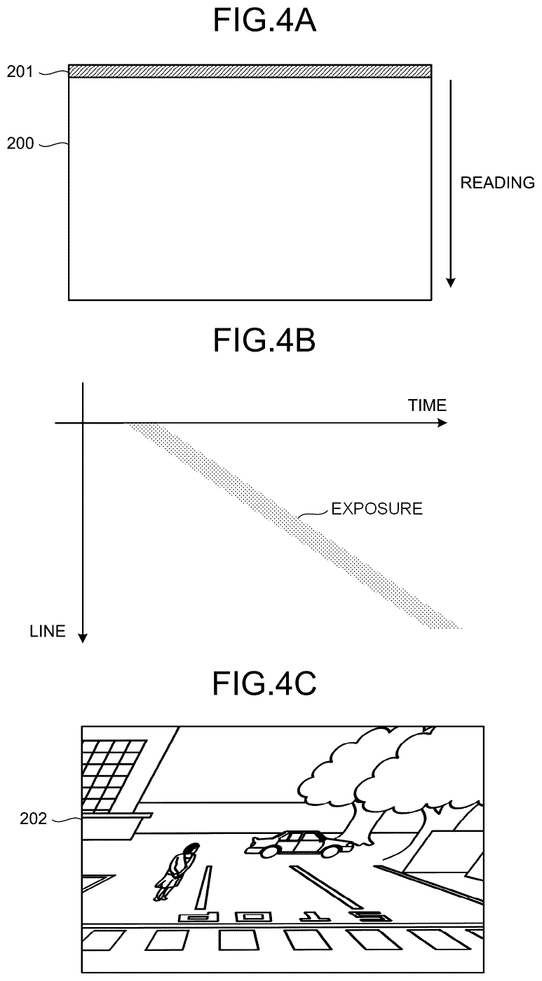

As imaging systems for imaging by the pixel array unit 101, a rolling shutter (RS) system and a global shutter (GS) system are known. First, the rolling shutter system will be schematically described. FIGS. 4A, 4B, and 4C are schematic diagrams for explaining the rolling shutter system. In the rolling shutter system, as illustrated in FIG. 4A, imaging is sequentially performed in units of lines from a line 201 at an upper end of a frame 200, for example.

In the above description, “imaging” has been described to refer to the operation in which the sensor 11 outputs a pixel signal according to light with which the light receiving surface was irradiated. More specifically, “imaging” refers to a series of operations from exposure of a pixel to transfer of a pixel signal based on electric charges accumulated by the exposure in a photoelectric conversion element included in the pixel to the data processing unit 13 and the line memory 14. Furthermore, an image for one frame is captured by the pixel region valid for generating a pixel signal in the pixel array unit 101.

For example, in the configuration illustrated in FIG. 3, exposure is simultaneously executed in each pixel circuit 100 included in one line. After the exposure ends, pixel signals based on electric charges accumulated by the exposure are simultaneously transferred from the respective pixel circuits 100 included in the line via the respective vertical signal lines VSL corresponding to the respective pixel circuits 100. By sequentially executing this operation in units of lines, it is possible to implement imaging by the rolling shutter.

FIG. 4B schematically illustrates an example of a relationship between imaging and time in the rolling shutter system. In FIG. 4B, the vertical axis represents a line position, and the horizontal axis represents time. In the rolling shutter system, since the exposure in each line is performed line by line, as illustrated in FIG. 4B, the exposure timing in each line is sequentially shifted according to the position of the line. Therefore, for example, in a case where the positional relationship between the imaging device 1 and a subject in the horizontal direction changes at a high speed, distortion occurs in a captured image of the frame 200 as illustrated in FIG. 4C. In the example illustrated in FIG. 4C, an image 202 corresponding to the frame 200 is an image inclined at an angle corresponding to the speed of change and the direction of change in the positional relationship between the imaging device 1 and the subject in the horizontal direction.

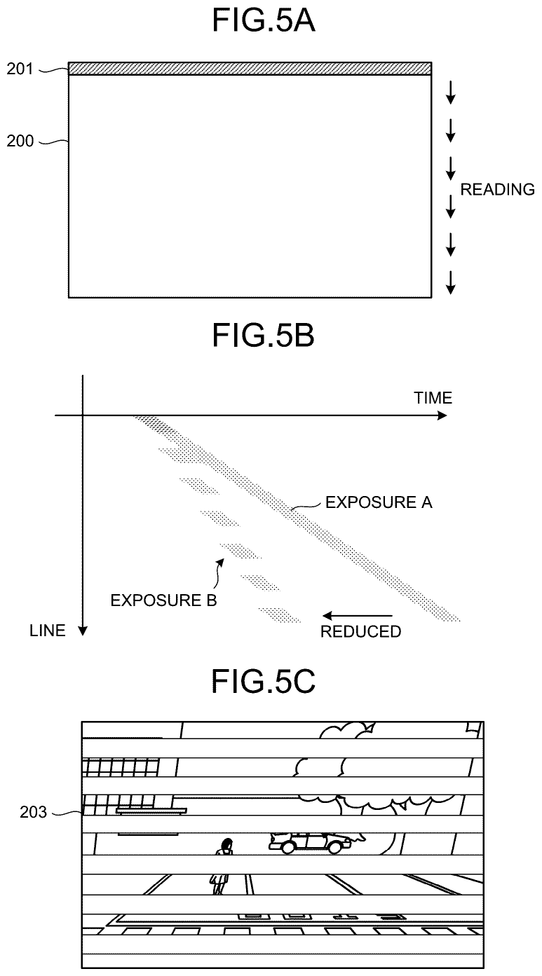

In the rolling shutter system, it is also possible to perform imaging by thinning out a line. FIGS. 5A, 5B, and 5C are schematic diagrams for explaining line thinning in the rolling shutter system. As illustrated in FIG. 5A, similarly to the example illustrated in FIG. 4A described above, imaging is performed in units of lines from the line 201 at the upper end of the frame 200 toward a lower end of the frame 200. In this case, the imaging is performed while skipping every predetermined number of lines.

Here, for the sake of explanation, it is assumed that imaging is performed every other line by one-line thinning. That is, after imaging of the nth line, imaging of the (n+2)th line is performed. In this case, it is assumed that time from the imaging of the nth line to the imaging of the (n+2)th line is equal to time from imaging of the nth line to imaging of the (n+1)th line in a case where thinning is not performed.

FIG. 5B schematically illustrates an example of a relationship between imaging and time in a case where the one-line thinning is performed in the rolling shutter system. In FIG. 5B, the vertical axis represents a line position, and the horizontal axis represents time. In FIG. 5B, exposure A corresponds to the exposure in FIG. 4B in a case where thinning is not performed, and exposure B indicates exposure in a case where the one-line thinning is performed. As indicated by the exposure B, by performing the line thinning, it is possible to shorten a difference in exposure timing at the same line position as compared with a case where the line thinning is not performed. Therefore, as illustrated as an image 203 in FIG. 5C, distortion in an inclination direction generated in the captured image of the frame 200 is smaller than that in a case where the line thinning illustrated in FIG. 4C is not performed. On the other hand, when the line thinning is performed, the resolution of the image is lower than that in a case where the line thinning is not performed.

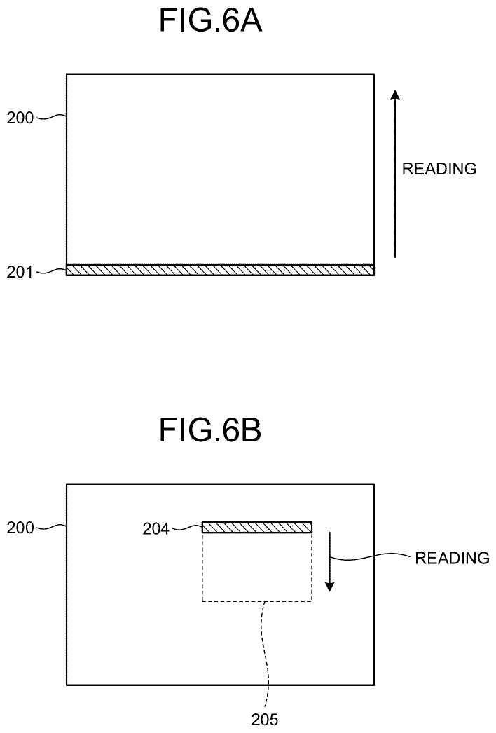

In the above description, the example has been described in which the imaging is performed line by line from the upper end to the lower end of the frame 200 in the rolling shutter system, but this is not limited to this example. FIGS. 6A and 6B are diagrams schematically illustrating examples of other imaging methods in the rolling shutter system. For example, as illustrated in FIG. 6A, in the rolling shutter system, imaging can be performed line by line from the lower end to the upper end of the frame 200. In this case, the horizontal direction of the distortion of the image 202 is reversed as compared with the case where the imaging is performed line by line from the upper end to the lower end of the frame 200.

In addition, for example, by setting a range of a vertical signal line VSL to which a pixel signal is transferred, it is also possible to selectively read out a part of a line. Furthermore, by setting each of the line for performing imaging and the vertical signal line VSL for transferring the pixel signal, lines for starting and ending imaging can be set to other than the upper end and the lower end of the frame 200. FIG. 6B schematically illustrates an example in which a rectangular region 205 whose width and height are less than the width and height of the frame 200 is set as an imaging range. In the example illustrated in FIG. 6B, imaging is performed line by line from a line 204 at an upper end of the region 205 toward a lower end of the region 205.

### 2-2. Outline of Global Shutter

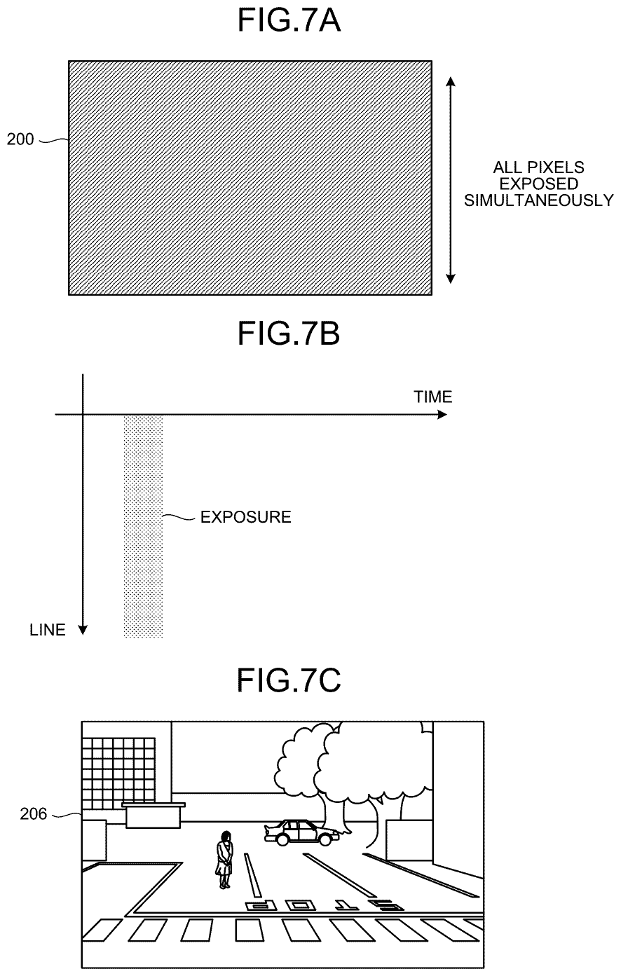

Next, the global shutter (GS) system will be schematically described as an imaging system in a case where imaging is performed by the sensor 11. FIGS. 7A, 7B, and 7C are schematic diagrams for explaining the global shutter system. In the global shutter system, as illustrated in FIG. 7A, exposure is simultaneously performed in all the pixel circuits 100 included in the frame 200.

In a case where the global shutter system is implemented in the configuration illustrated in FIG. 3, as an example, it is conceivable to have a configuration in which a capacitor is further provided between the photoelectric conversion element and the FD in each pixel circuit 100. Then, a first switch is provided between the photoelectric conversion element and the capacitor, and a second switch is provided between the capacitor and the floating diffusion layer, and opening and closing of each of the first and second switches is controlled by a pulse supplied via the pixel signal line 106.

In such a configuration, during an exposure period, in each of all the pixel circuits 100 included in the frame 200, the first and second switches are opened, and the first switch is changed from the opened state to the closed state at the end of the exposure to transfer electric charges from the photoelectric conversion element to the capacitor. Thereafter, the capacitor is regarded as a photoelectric conversion element, and electric charges are read from the capacitor in a sequence similar to the read operation described above for the rolling shutter system. This enables simultaneous exposure in all the pixel circuits 100 included in the frame 200.

FIG. 7B schematically illustrates an example of a relationship between imaging and time in the global shutter system. In FIG. 7B, the vertical axis represents a line position, and the horizontal axis represents time. In the global shutter system, since exposure is simultaneously performed in all the pixel circuits 100 included in the frame 200, the exposure timings in the lines can be the same as illustrated in FIG. 7B. Therefore, for example, even in a case where the positional relationship between the imaging device 1 and the subject in the horizontal direction changes at a high speed, distortion according to the change does not occur in a captured image 206 of the frame 200 as illustrated in FIG. 7C.

In the global shutter system, the simultaneity of the exposure timings in all the pixel circuits 100 included in the frame 200 can be secured. Therefore, by controlling the timing of each pulse supplied by the pixel signal line 106 of each line and the timing of transfer by each vertical signal line VSL, it is possible to implement sampling (reading of pixel signals) in various patterns.

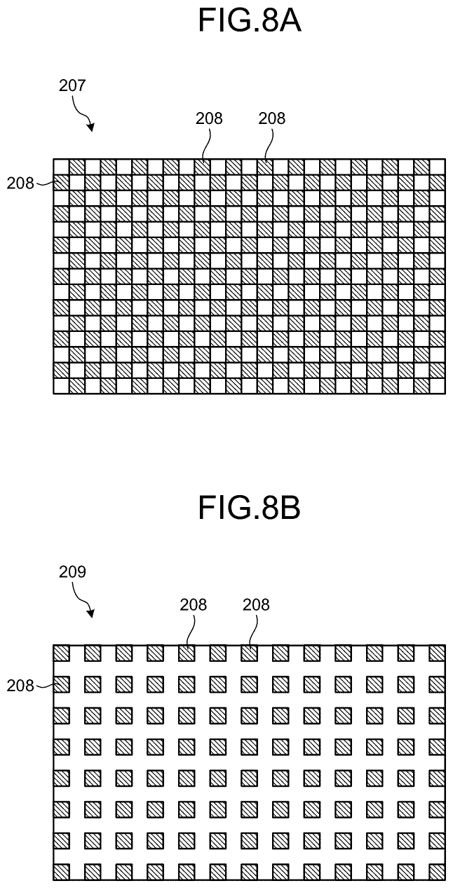

FIGS. 8A and 8B are diagrams schematically illustrating examples of the patterns of the sampling that can be implemented in the global shutter system. FIG. 8A illustrates an example in which samples 208 for reading pixel signals from the pixel circuits 100 included in the frame 200 and arranged in a matrix are extracted in a checkered pattern. Furthermore, FIG. 8B is an example of extracting samples 208 from which pixel signals are read out from the respective pixel circuits 100 in a lattice pattern. In addition, also in the global shutter system, similarly to the rolling shutter system described above, imaging can be performed line by line.

### 2-3. Regarding DNN

Next, recognition processing using a deep neural network (DNN) applicable to the first embodiment will be schematically described. In the first embodiment, a convolutional neural network (CNN) among DNNs is used to perform recognition processing on image data. Hereinafter, “recognition processing on image data” is appropriately referred to as “image recognition processing” or the like.

### 2-3-1. Overview of CNN

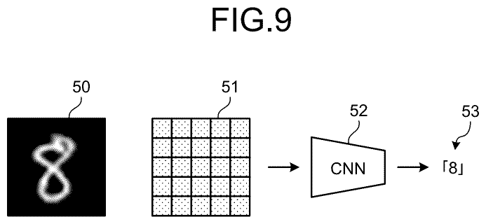

First, the CNN will be schematically described. In general, the image recognition processing by the CNN performs image recognition processing based on image information by pixels arranged in a matrix, for example. FIG. 9 is a diagram schematically illustrating the image recognition processing by the CNN. Processing by a CNN 52 trained in a predetermined manner is performed on entire pixel information 51 of an image 50 on which a number “8” that is an object to be recognized is drawn. As a result, the number “8” is recognized as a recognition result 53.

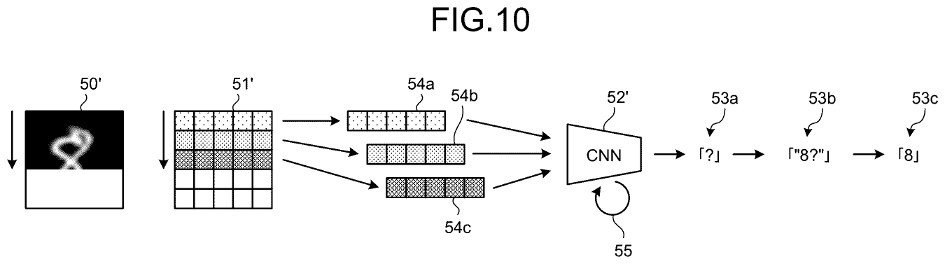

On the other hand, it is also possible to obtain a recognition result from a part of the image to be recognized by performing processing by the CNN based on an image for each line. FIG. 10 is a diagram schematically illustrating image recognition processing of obtaining a recognition result from a part of an image to be recognized. In FIG. 10, an image 50′ is obtained by partially acquiring the number “8”, which is the object to be recognized, in units of lines. For example, pixel information 54a, 54b, and 54c for each line forming pixel information 51′ of the image 50′ is sequentially processed by a CNN 52′ trained in advance.

For example, it is assumed that a recognition result 53a obtained by recognition processing by the CNN 52′ on the pixel information 54a of the first line is not a valid recognition result. In this case, the valid recognition result refers to, for example, a recognition result in which a score indicating the reliability of the recognized result is equal to or higher than a predetermined score. The CNN 52′ performs an update 55 to update an internal state based on the recognition result 53a. Next, recognition processing is performed on the pixel information 54b of the second line by the CNN 52′ whose internal state has been updated by the update 55 according to the previous recognition result 53a. In FIG. 10, as a result, a recognition result 53b indicating that a number to be recognized is either “8” or “9” is obtained. Furthermore, internal information of the CNN 52′ is updated by the update 55 based on the recognition result 53b. Next, recognition processing is performed on the pixel information 54c of the third line by the CNN 52′ whose internal state has been updated by the update 55 according to the previous recognition result 53b. In FIG. 10, as a result, numbers to be recognized is narrowed down to “8” out of “8” or “9”.

In this case, in the recognition processing illustrated in FIG. 10, the internal state of the CNN is updated using a result of previous recognition processing, and the recognition processing is performed using pixel information of a line adjacent to a line on which the previous recognition processing has been performed by the CNN whose internal state has been updated. That is, the recognition processing illustrated in FIG. 10 is executed on the image line by line while updating the internal state of the CNN based on the previous recognition result. Therefore, the recognition processing illustrated in FIG. 10 is processing recursively executed line by line, and can be considered to have a structure corresponding to a recurrent neural network (RNN).

### 2-4. Regarding Driving Speed

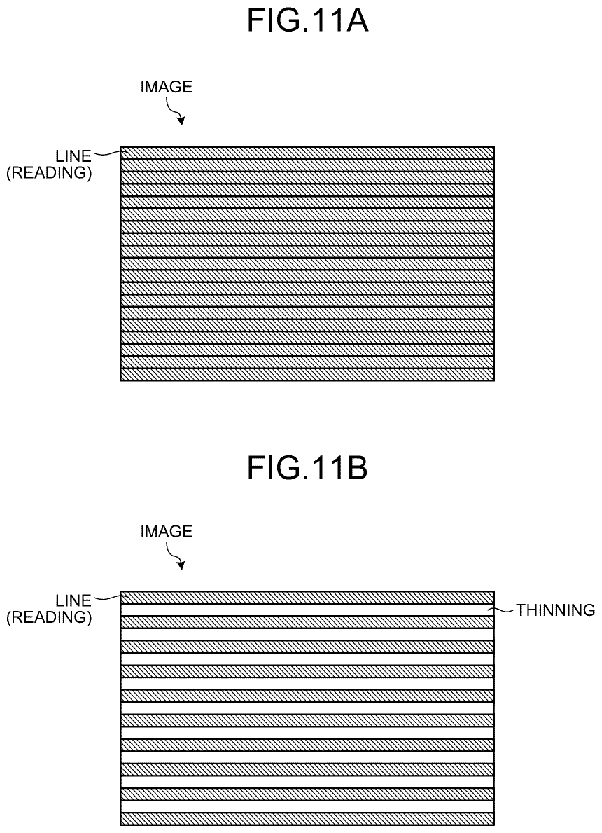

Next, the relationship between a driving speed of a frame and the amount of a read pixel signal will be described with reference to FIGS. 11A and 11B. FIG. 11A is a diagram illustrating an example in which all lines in an image are read. In this case, it is assumed that the resolution of the image to be subjected to the recognition processing has 640 pixels in the horizontal direction×480 pixels (480 lines) in the vertical direction. In this case, driving at a driving speed of 14400 [line/second] enables output at 30 [frame per second (fps)].

Next, it is considered that imaging is performed by thinning out lines. For example, as illustrated in FIG. 11B, it is assumed that imaging is performed by ½ thinning reading in which imaging is performed by skipping one line every two lines. As a first example of ½ thinning, in a case where driving is performed at a driving speed of 14400 [lines/second] in the same manner as described above, the number of lines to be read from the image is ½. Therefore, although the resolution is reduced, it is possible to output at 60 [fps] which is twice the speed in a case where thinning is not performed, and the frame rate can be improved. As a second example of ½ thinning, in a case where driving is performed at a driving speed of 7200 [fps], which is a half of that in the first example, the frame rate is 30 [fps] as in a case where no thinning is performed, but electric power can be saved.

Whether the thinning is not performed, the thinning is performed to increase the driving speed, or the thinning is performed to set the driving speed to be the same as that in the case where the thinning is not performed in order to read the lines of the image can be selected according to, for example, the purpose of the recognition processing based on read pixel signals.

### 3. Summary of Present Disclosure

The first embodiment of the present disclosure will be described in more detail. First, the processing according to the first embodiment of the present disclosure will be schematically described while being compared with the related art.

### 3-1. First Embodiment

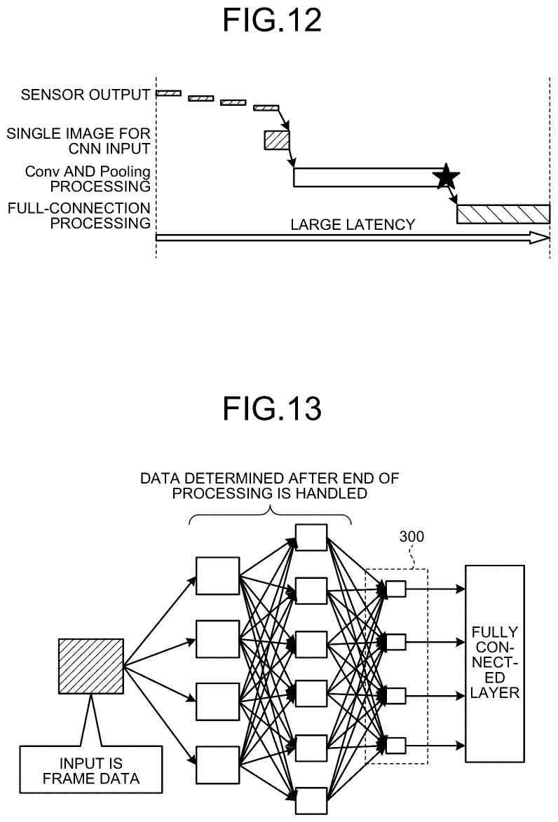

FIG. 12 is a diagram illustrating an example of processing time of a conventional image recognition function. FIG. 13 is a diagram illustrating an example of a memory region necessary for the conventional image recognition function. As illustrated in FIG. 13, a conventional CNN inputs one frame image to a network. An image sensor reads data in units of one to several lines. Therefore, as illustrated in FIG. 12, it has been necessary to store a frame image in a frame buffer and wait until the frame image is obtained. Conventionally, there has been a problem of a decrease in an available limited region of the image sensor due to the necessity of the frame buffer. In addition, since processing cannot be started until data for one frame is stored, a problem that the latency increases has occurred.

That is, conventionally, the processing is started after frame data as input data of each layer is determined, and a determined value after the processing is repeatedly transmitted to the next layer.

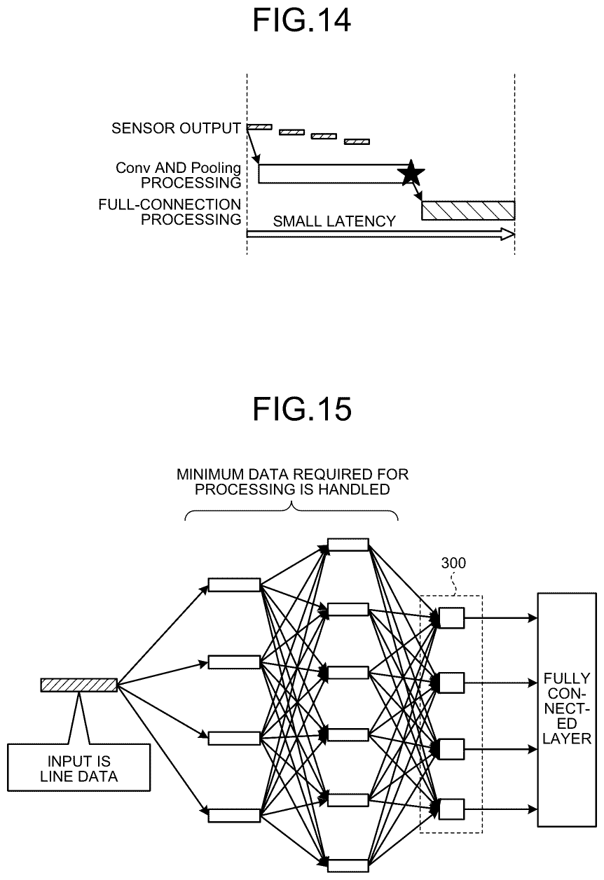

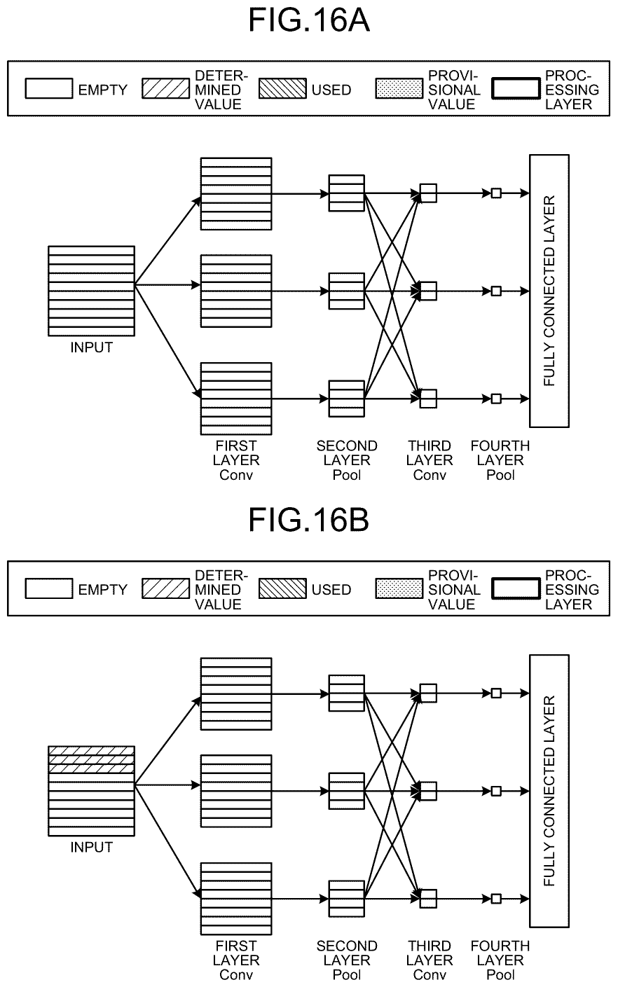

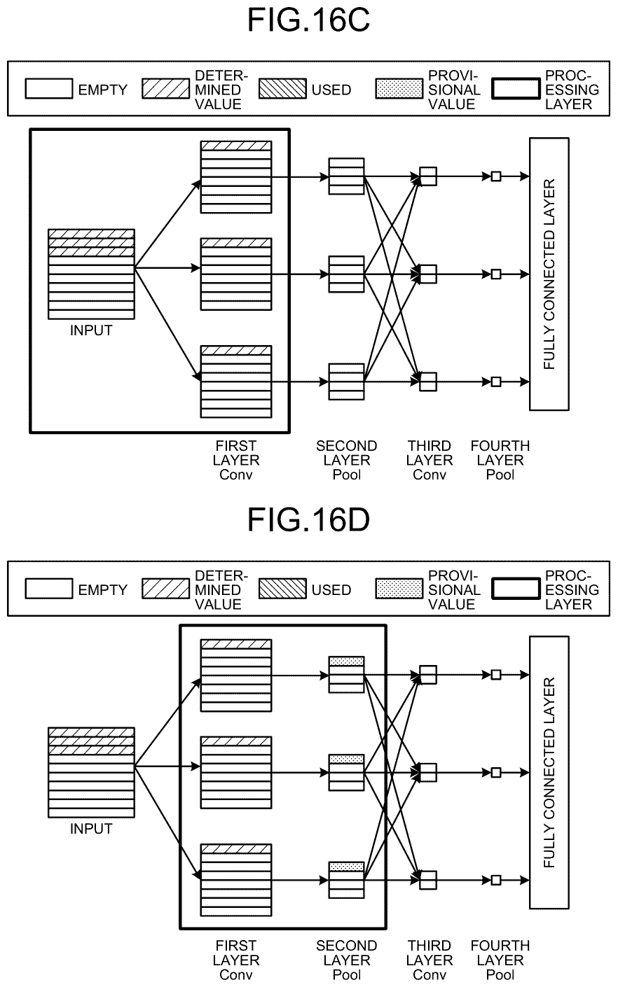

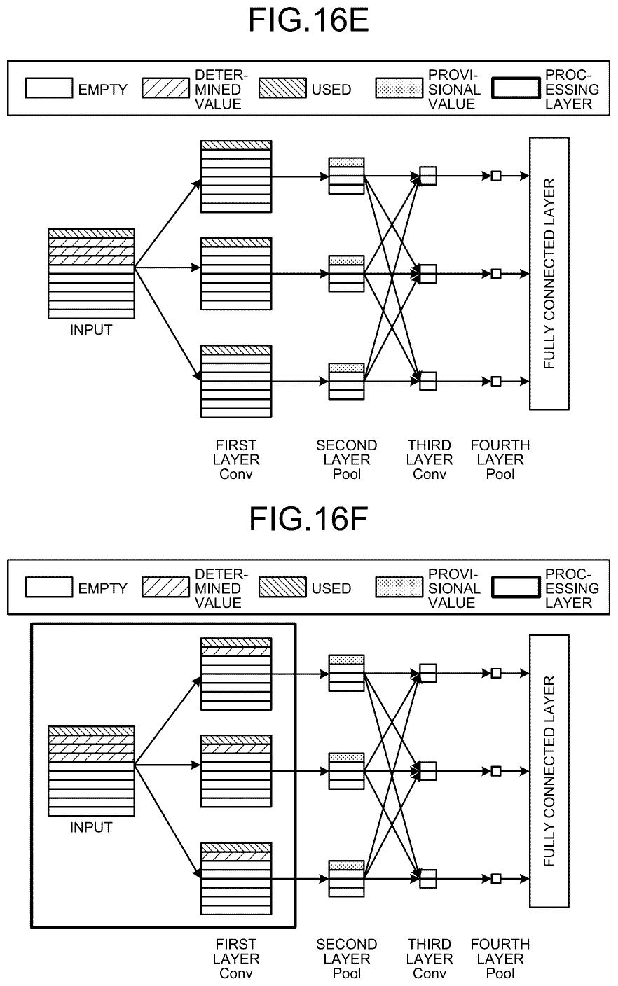

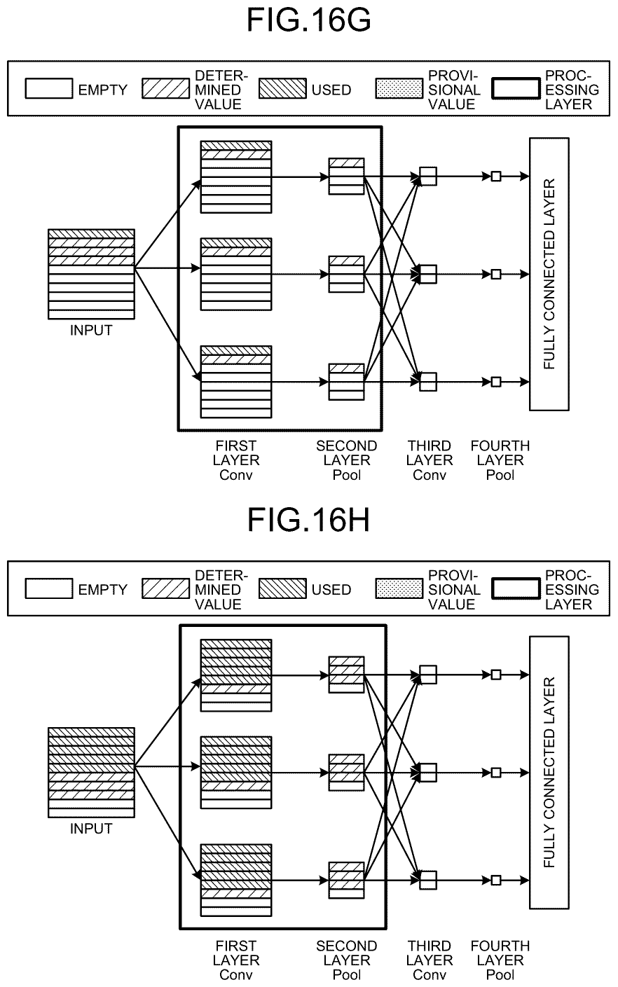

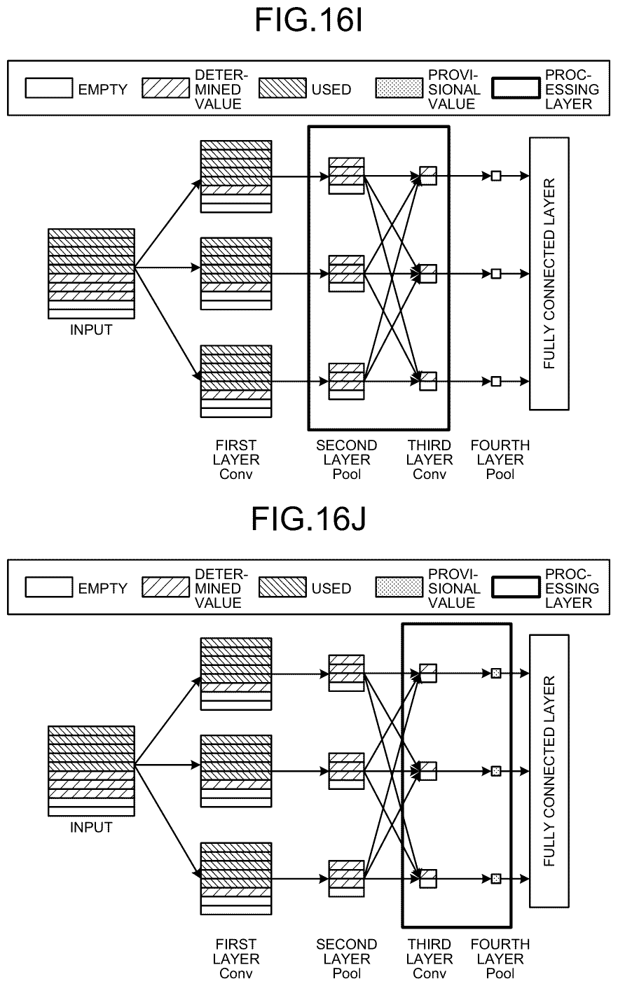

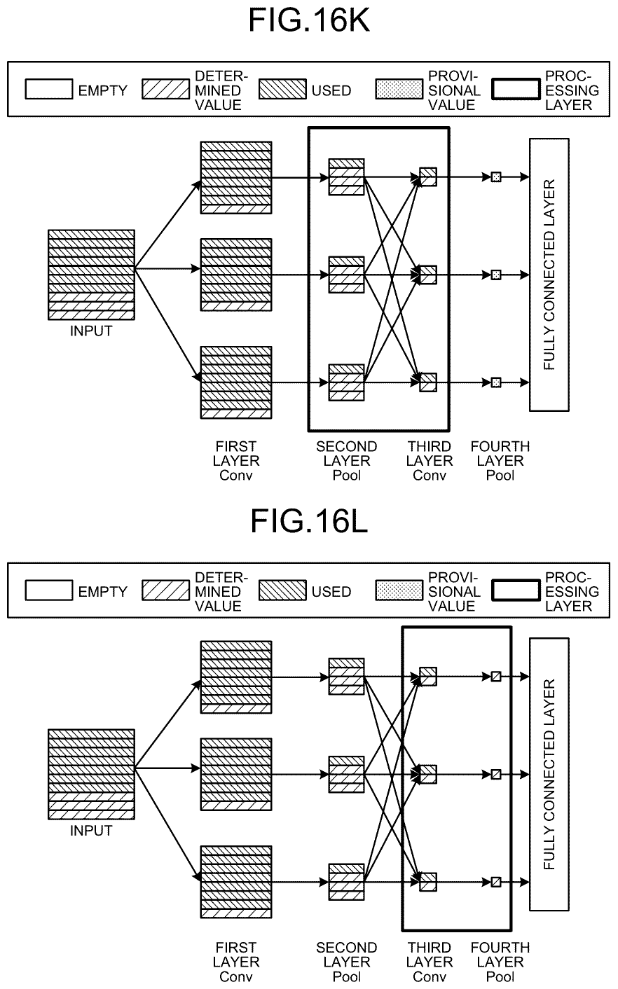

FIG. 14 is a diagram illustrating an example of processing time of an image recognition function according to the first embodiment. FIG. 15 is a diagram illustrating an example of a memory region necessary for the image recognition function according to the first embodiment. The first embodiment is greatly different from the related art in that processing is performed at a timing when necessary data is accumulated in the next layer and processing is performed by returning to the previous layer, unlike the related art in which processing is completed in each layer and then proceeds to processing of the next layer. Note that details of the processing in the first embodiment will be described later with reference to FIGS. 16A to 16L.

As an implementation means, as long as a value of a buffer 300 illustrated in FIGS. 13 and 15 does not change, even if the processing in the middle is decomposed in units of lines, processing equivalent to the conventional frame-based processing can be implemented. Therefore, in the first embodiment, only the buffer 300 is left as a frame buffer (but is often a pixel buffer compressed to 1 pix), and a buffer that stores data of the previous layer is replaced with the minimum necessary line buffer.

The data decomposed in units of lines is sequentially processed and sent to the next layer, and is stored in the buffer 300 as a provisional value. The buffer 300 continues the update, and the value is determined at the timing (a star mark in FIG. 14) when the processing of the last line is completed. Since the value of the buffer 300 at the timing indicated by the star mark is the same in the frame-based processing and the line-based processing, a processing result of a fully connected layer is also consistent with that in the frame-based processing. As a result, even if decomposition is performed in units of lines, processing equivalent to the conventional frame-based processing can be implemented.

FIGS. 16A to 16L are diagrams illustrating an example of convolution processing and MaxPooling processing according to the first embodiment. In the example of FIGS. 16A to 16L, the first layer is convolution processing by a filter of a 3×3 size, the second layer is MaxPooling processing for a region of a 2×2 size, the third layer is convolution processing by a filter of a 3×3 size, and the fourth layer is MaxPooling processing for a region of a 2×2 size.

FIG. 16A illustrates an initial state (data is an initial value and is empty).

FIG. 16B illustrates a state in which input of processing for the first row in the first layer by the first processing unit 152 is confirmed. The first processing unit 152 reads data for processing of the first layer from the line memory 14.

FIG. 16C illustrates a state in which the processing for the first row in the first layer by the first processing unit 152 is completed.

FIG. 16D illustrates a provisional state of processing for the first row in the second layer by the first processing unit 152. The first processing unit 152 holds the maximum value of the first row in the first layer as a provisional value in the first row in the second layer.

FIG. 16E illustrates a state in which input of processing for the second row in the first layer by the first processing unit 152 is confirmed. The first processing unit 152 reads an additional one row from the line memory 14 for the next convolution processing using a filter of a 3× 3 size.

FIG. 16F illustrates a state in which the processing for the second row in the first layer by the first processing unit 152 is completed.

FIG. 16G illustrates a state in which the processing for the first row in the second layer by the first processing unit 152 is completed. The first processing unit 152 compares the second row in the first layer with the first row in the second layer to determine the maximum value, and completes the processing for the first row in the second layer.

FIG. 16H illustrates a state in which the processing for the third row in the second layer by the first processing unit 152 is completed. The first processing unit 152 repeats processing similar to the processing of FIGS. 16B to 16G to complete the processing for up to the third row in the second layer.

FIG. 16I illustrates a state in which the processing for the first row in the third layer by the first processing unit 152 is completed. Since the data of the two layers each having three rows is prepared, the first processing unit 152 executes the convolution processing of the third layer by a filter of a 3×3 size and completes the processing for the first row in the third layer.

FIG. 16J illustrates a provisional state of processing of the fourth layer by the first processing unit 152. The first processing unit 152 holds the maximum value of the first row in the third layer as a provisional value in the fourth layer.

FIG. 16K illustrates a state in which the processing for the second row in the third layer by the first processing unit 152 is completed. The first processing unit 152 performs processing similar to the processing of FIGS. 16H and 16I to complete the processing for up to the second row in the third layer.

FIG. 16L illustrates a state in which the processing of the fourth layer by the first processing unit 152 is completed. The first processing unit 152 compares the second row in the third layer with the fourth layer to determine the maximum value, and completes the processing of the fourth layer.

As illustrated in FIGS. 16A to 16L, there are two methods for executing processing on a line basis. The methods are a method of securing the line memory 14 for the filter size for the convolution processing, and a method of decomposing the line memory 14 corresponding to the filter size for the convolution processing in units of one line. In the first embodiment, the method of securing the line memory 14 corresponding to the filter size for the convolution processing will be described. The method of decomposing the line memory 14 corresponding to the filter size for the convolution processing in units of one line will be described in a second embodiment.

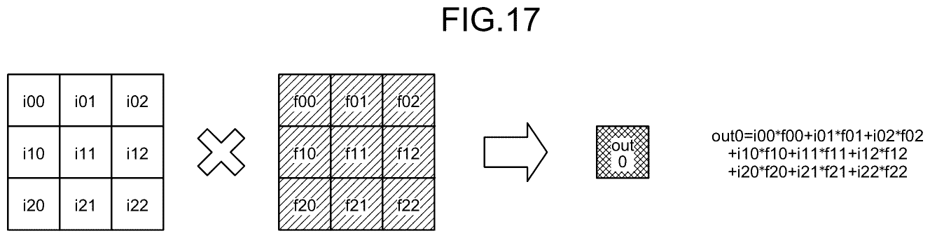

FIG. 17 is a diagram illustrating a decomposition example (in the case of units of convolution) of processing in the first embodiment. For example, in a case where convolution is performed using a filter of a 3×3 size, input can be implemented in a case where data for three lines is present. In the first embodiment, the line memory 14 reserves sensor data for three lines. The first processing unit 152 clears the line memory 14 after executing the convolution processing, and executes the convolution processing again when the next three lines are accumulated in the line memory 14. The memory can be saved by reuse of the line memory 14.

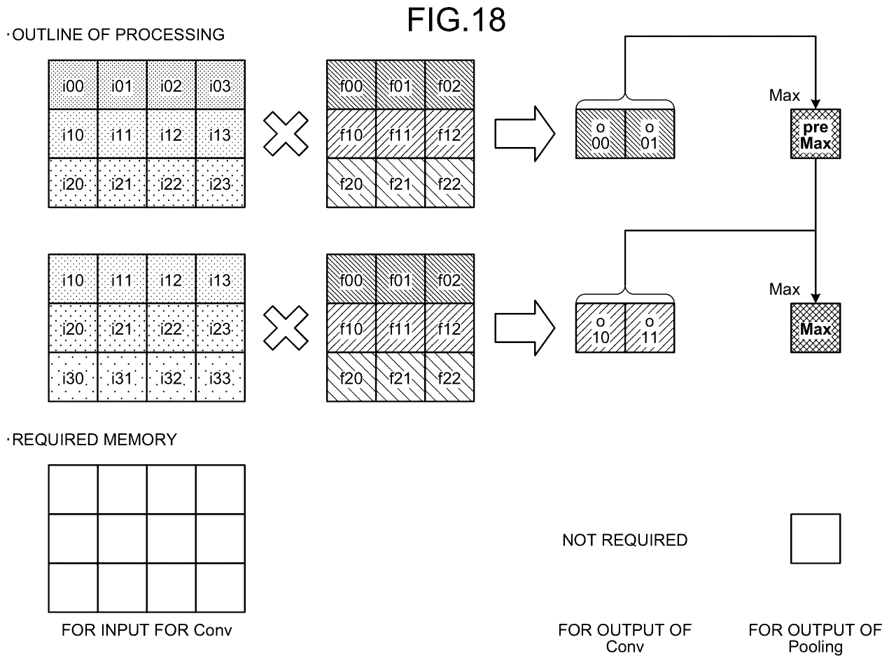

FIG. 18 is a diagram illustrating Example 1 of the processing in the first embodiment. In the example of FIG. 18, input data has a 4×4 size, the first layer is convolution processing by a filter of a 3×3 size, and the second layer is MaxPooling processing for a region of a 2×2 size. In the example illustrated in FIG. 18, a memory (the line memory 14 in the configuration example illustrated in FIG. 1) for input for the convolution processing is required. In addition, since it is necessary to hold a provisional maximum value (pre Max) of MaxPooling processing, a memory (buffer) for output of pooling is required.

In the example illustrated in FIG. 18, for example, an output o00 of the convolution processing is calculated by 100*f00+i01*f01+i02*f02+i10*f10+i11*f11+i12*f12+i20*f20+i21*f21+i22*f22. Further, for example, an output o01 of the convolution processing is calculated by i01*f00+i02*f01+i03*f02+i11*f10+i12*f11+i13*f12+i21 f20+i22*f21+i23*f22.

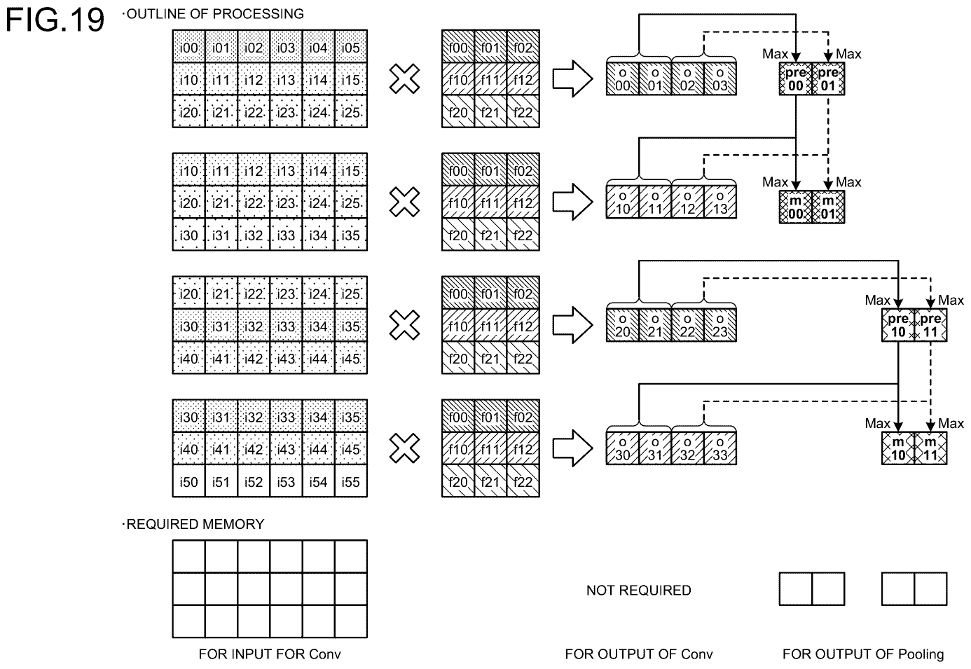

FIG. 19 is a diagram illustrating Example 2 of the processing in the first embodiment. In the example illustrated in FIG. 19, input data has a 6×6 size, the first layer is convolution processing by a filter of a 3×3 size, and the second layer is MaxPooling processing for a region of a 2×2 size. In the example illustrated in FIG. 19, a memory (the line memory 14 in the configuration example illustrated in FIG. 1) for input for the convolution processing is required. In addition, since it is necessary to hold a provisional maximum value (pre Max) of MaxPooling processing, a memory (buffer) for output of pooling is required.

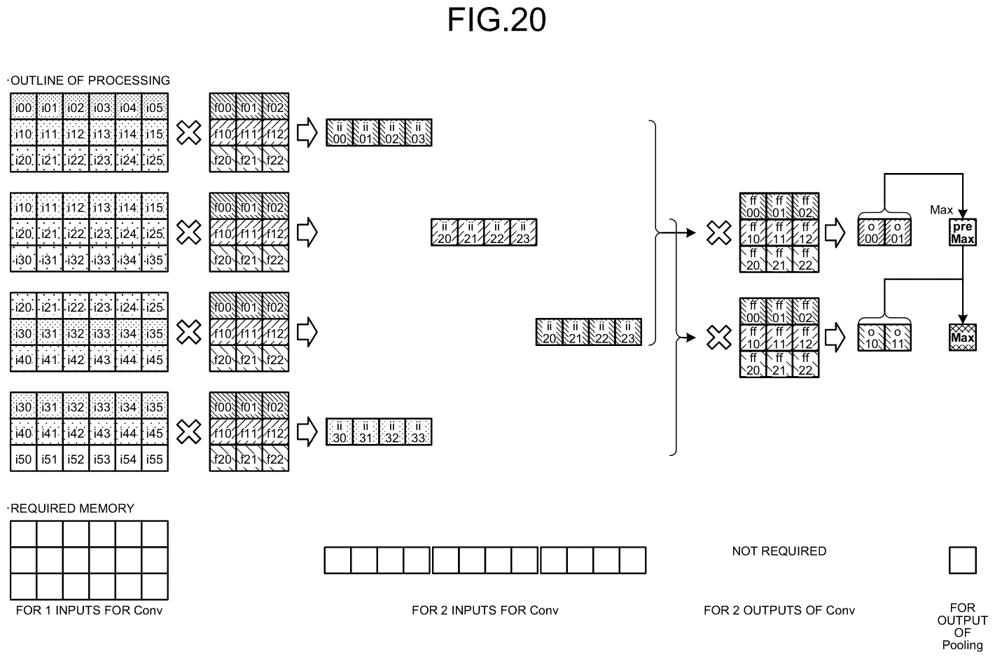

FIG. 20 is a diagram illustrating Example 3 of the processing in the first embodiment. In the example illustrated in FIG. 19, input data has a 6×6 size, the first layer is convolution processing by a filter of a 3×3 size, the second layer is convolution processing by a filter of a 3×3 size, and the third layer is MaxPooling processing for a region of a 2× 2 size. In the example illustrated in FIG. 20, a memory (the line memory 14 in the configuration example illustrated in FIG. 1) for input for the convolution processing of the first layer is required. In addition, a memory (buffer) for input for the convolution processing of the second layer is required. In addition, since it is necessary to hold a provisional maximum value (pre Max) of MaxPooling processing, a memory (buffer) for output of pooling is required.

As illustrated in FIGS. 18 to 20, the memory region necessary for the image recognition function can be reduced as compared with the conventional frame-based processing. Note that, in the conventional frame-based processing, since the processing is completed for each layer, a memory (a memory for outputting the processing result of the previous layer) for input for the convolution processing and MaxPooling processing can be reused, but a memory region for at least one frame is required as a memory region of the worst usage amount.

As described above, in the first embodiment, the sensor 11 captures an image for one frame by a pixel region in which a plurality of pixels is arranged. The first processing unit 152 executes the convolution processing in the predetermined line unit read from the pixel region instead of the image unit for one frame, and executes the feature amount extraction processing based on a result of executing the convolution processing. Then, the second processing unit 153 executes the full-connection processing based on the result of the feature amount extraction processing, and outputs an inference result based on the result of the full-connection processing.

As a result, according to the first embodiment, it is possible to suppress the processing time and the memory region involved in implementing the image recognition function.

### 3-2. Second Embodiment

Next, the second embodiment will be described. In the description of the second embodiment, a description similar to that of the first embodiment will be omitted, and portions different from those of the first embodiment will be described. In the second embodiment, a method of decomposing a line memory 14 corresponding to a filter size for convolution processing in units of one line (in units of pixels of one line) will be described.

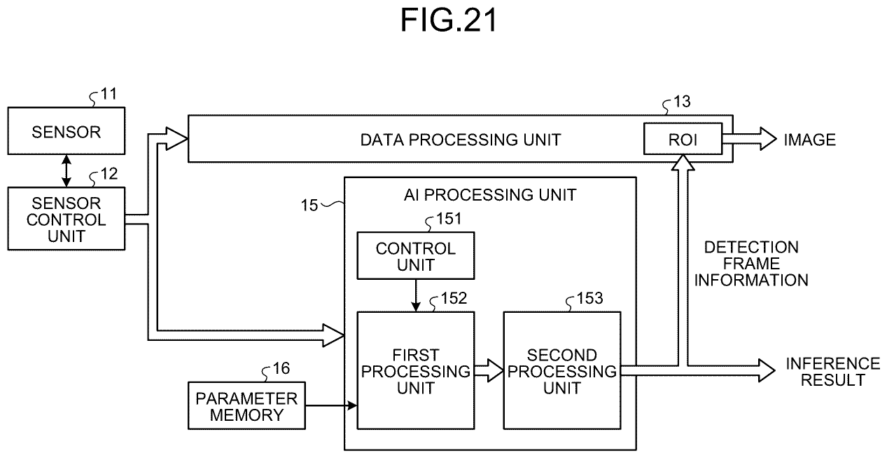

FIG. 21 is a block diagram illustrating a configuration of an example of an imaging device applicable to the second embodiment. In FIG. 21, an imaging device 1 includes a sensor 11, a sensor control unit 12, a data processing unit 13, an artificial intelligence (AI) processing unit 15, and a parameter memory 16. In the second embodiment, since the line memory 14 is decomposed into units of one line, it is not necessary to hold data corresponding to the filter size for the convolution processing, and thus, it can be implemented without the line memory 14.

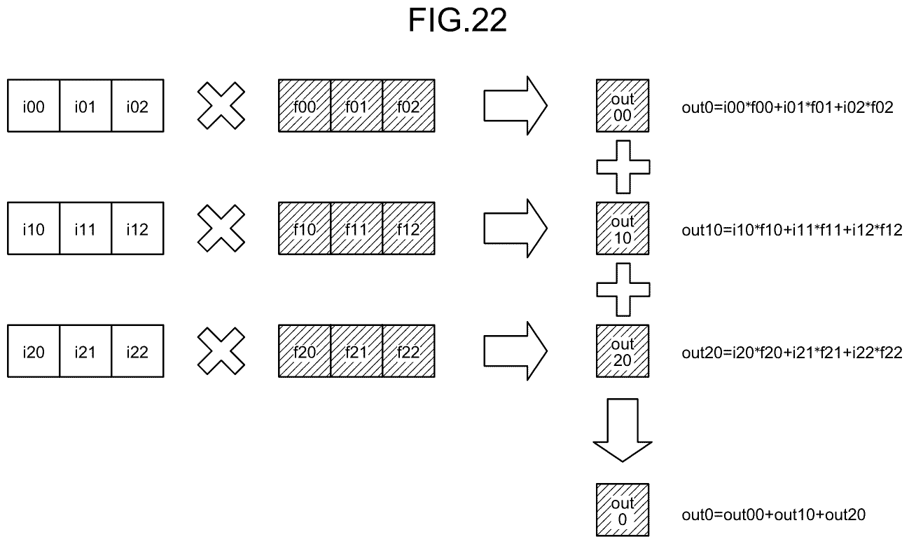

FIG. 22 is a diagram illustrating a decomposition example (in the case of units of one line) of processing in the second embodiment. For example, in the case of performing convolution with a filter of a 3×3 size, the line memory 14 secures 3 lines of sensor data in the first embodiment (see FIG. 17), but in the second embodiment, as illustrated in FIG. 22, the line memory 14 is further decomposed into units of one line. When the convolution processing is continued a plurality of times, the processing becomes complex. However, depending on the network, the memory can be further reduced as compared with the processing method (the method of securing the line memory 14 corresponding to the filter size of the convolution processing) in units of convolution described in the first embodiment. For example, in a network in which MaxPooling processing is performed after the convolution processing is continued a plurality of times, the memory can be further reduced.

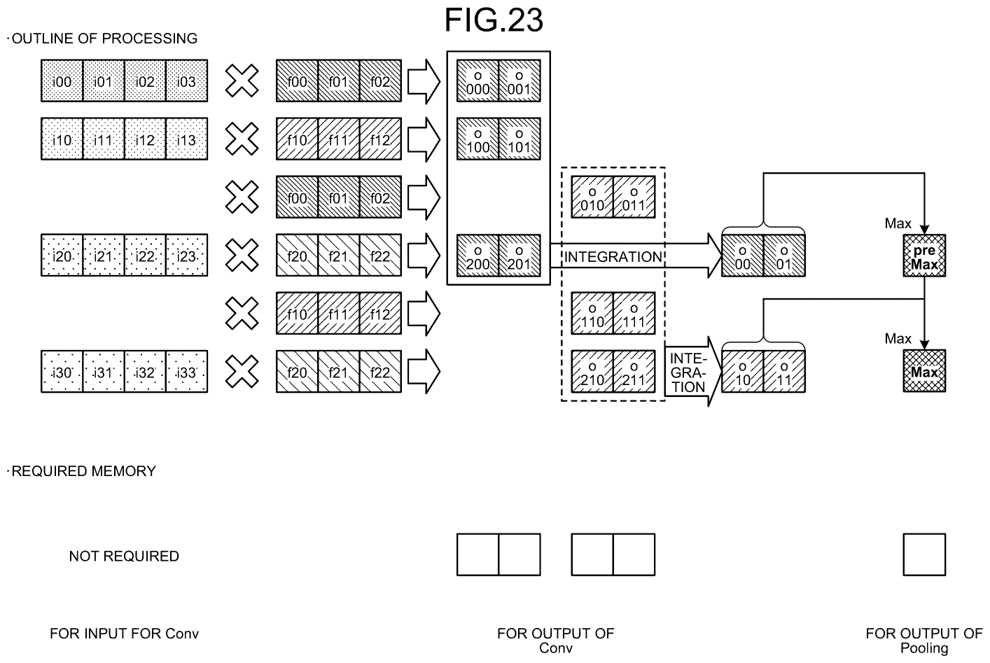

FIG. 23 is a diagram illustrating Example 1 of the processing in the second embodiment. In the example illustrated in FIG. 23, input data has a 4×4 size, the first layer is convolution processing by a filter of a 3×3 size, and the second layer is MaxPooling processing for a region of a 2×2 size. In the example of FIG. 23, a memory for input for the convolution processing is not necessary, but since it is necessary to integrate the convolution processing executed in units of one line, a memory (buffer) for holding a result of the convolution processing executed in units of one line is required. In addition, since it is necessary to hold a provisional maximum value (pre Max) of MaxPooling processing, a memory (buffer) for output of pooling is required.

In the example of FIG. 23, for example, outputs o000, o001, o100, o101, o010, and o011 of the convolution processing decomposed in units of one line are calculated as follows.

$$o 000 = i 00 ⋆ f 00 + i 01 ⋆ f 01 + i 02 ⋆ f 02$$

$$o 001 = i 01 ⋆ f 00 + i 02 ⋆ f 01 + i 03 ⋆ f 02$$

$$o 100 = i 10 ⋆ f 10 + i 11 ⋆ f 11 + i 12 ⋆ f 12$$

$$o 101 = i 11 ⋆ f 10 + i 11 ⋆ f 11 + i 13 ⋆ f 12$$

$$o 010 = i 10 ⋆ f 00 + i 11 ⋆ f 01 + i 12 ⋆ f 02$$

$$o 011 = i 11 ⋆ f 00 + i 12 ⋆ f 01 + i 13 ⋆ f 02$$

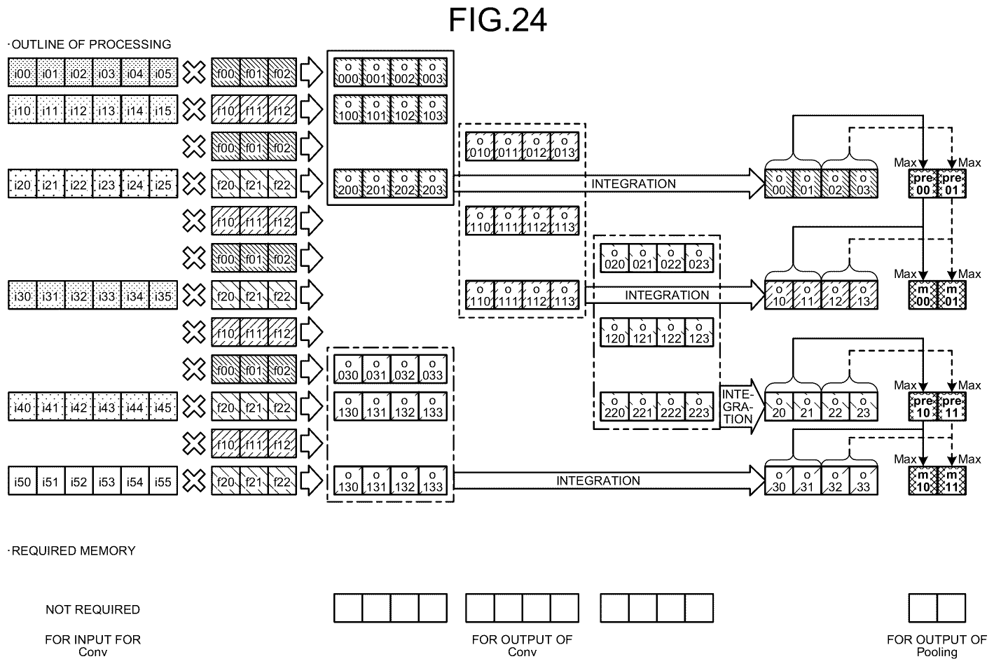

FIG. 24 is a diagram illustrating Example 2 of the processing in the second embodiment. In the example illustrated in FIG. 24, input data has a 6×6 size, the first layer is convolution processing by a filter of a 3×3 size, and the second layer is MaxPooling processing for a region of a 2×2 size. In the example of FIG. 24, a memory for input for the convolution processing is not necessary, but since it is necessary to integrate the convolution processing executed in units of one line, a memory (buffer) for holding a result of the convolution processing executed in units of one line is required. In addition, since it is necessary to hold a provisional maximum value (pre Max) of MaxPooling processing, a memory (buffer) for output of pooling is required.

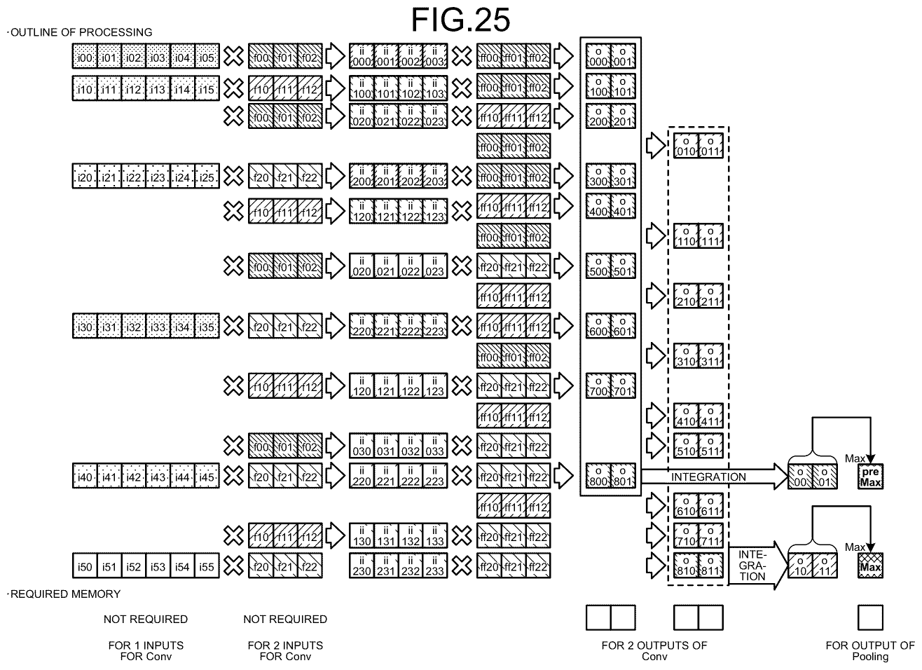

FIG. 25 is a diagram illustrating Example 3 of the processing in the second embodiment. In the example illustrated in FIG. 25, input data has a 6×6 size, the first layer is convolution processing by a filter of a 3×3 size, the second layer is convolution processing by a filter of a 3×3 size, and the third layer is MaxPooling processing for a region of a 2×2 size. In the example illustrated in FIG. 25, memories for input for the convolution processing of the first layer and the second layer are unnecessary, but since it is necessary to integrate the convolution processing executed in units of one line, a memory (buffer) for holding a result of the convolution processing executed in units of one line is required. In addition, since it is necessary to hold a provisional maximum value (pre Max) of MaxPooling processing, a memory (buffer) for output of pooling is required.

As illustrated in FIGS. 23 to 25, in the processing method in units of one line in the second embodiment, the memory region necessary for the image recognition function can be further reduced as compared with the processing method in units of convolution described in the first embodiment.

### 3-3. Example of Effects of First and Second Embodiments

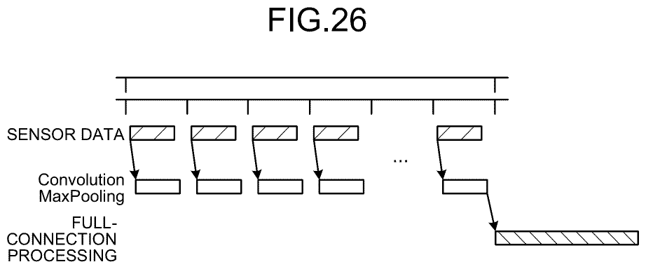

FIG. 26 is a diagram for explaining Example 1 of effects of the first and second embodiments. In a case where the number of processing channels is increased and the convolution processing and MaxPooling processing can be included in processing for one line, the processing can proceed to the full-connection processing upon the end of reading. That is, depending on parallelization, it is possible to end the convolution processing and MaxPooling processing during the reading and start the full-connection processing immediately after the reading. This is an advantage that cannot be achieved by the conventional frame-based processing (see FIGS. 12 and 13), and enables high-speed detection/identification, which is suitable, for example, for detection/identification of a high-speed moving object. For example, since the processing can proceed in parallel with the reading of line data from the sensor 11, it is possible to perform high-speed detection and identification. This makes it possible to detect and identify an object moving at a high speed with high accuracy.

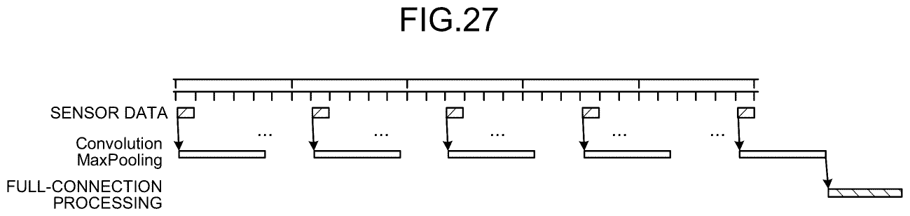

FIG. 27 is a diagram for explaining Example 2 of effects of the first and second embodiments. In a case where the convolution processing and MaxPooling processing are not included in processing for one line, a method of acquiring line data by shifting the line data in units of frames is considered. In the case of a stationary object or an object with slow movement, even when a frame is switched to another frame, the difference between the frames is small, and thus detection and identification can be performed by this method. In a case where the convolution processing and MaxPooling processing do not need to be included in the processing for one line, it is not necessary to increase the number of processing channels, and thus the circuit scale can be reduced.

### 3-4. Third Embodiment

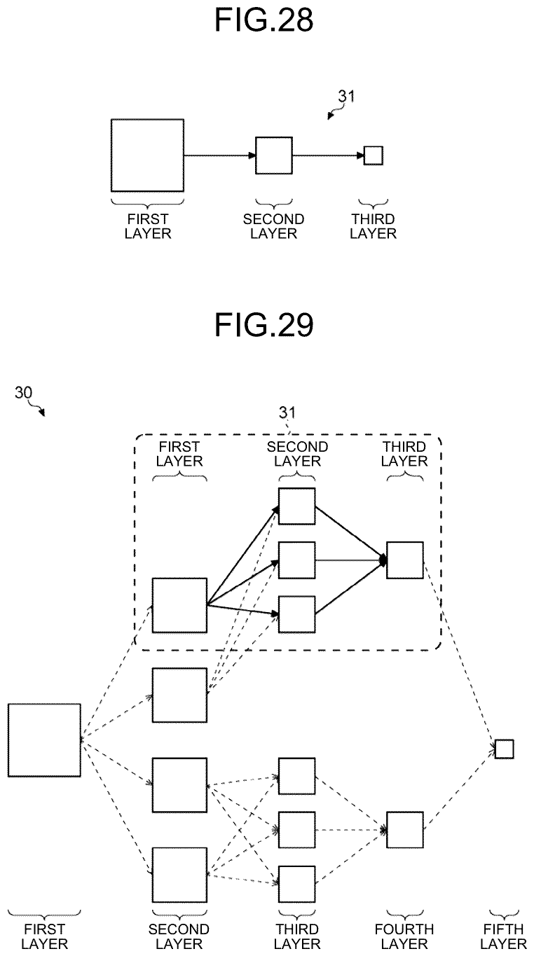

The processing executed by the AI processing unit 15 in the above-described embodiments is not limited to the exemplified recognition processing, and may be various types of processing using a network 31 having a layered structure as illustrated in FIG. 28, for example. Furthermore, as illustrated in FIG. 29, the network 31 may be a local network in an entire network 30. Note that the network 31 is not limited to the three-layer structure from the first layer to the third layer, and may be variously modified, like a two-layer structure or a layered structure of four or more layers.

Furthermore, the processing executed by the AI processing unit 15 is not limited to processing using a network structure such as a DNN, and various modifications can be made as long as a series of processing for one piece of image data can be divided into a plurality of steps, like rule-based pattern matching. In that case, some of the plurality of steps may be executed by the first processing unit 152, and at least some of the remaining steps may be executed by the second processing unit 153.

### 3-5. Fourth Embodiment

In addition, the processing executed by the first processing unit 152 and the second processing unit 153 in the AI processing unit 15 of the above-described embodiments is not limited to the exemplified convolution processing, feature amount extraction processing such as MaxPooling processing and the rage pooling processing, the full-connection processing, and the like, and can be variously changed. Some of variations of the processing that can be executed by the first processing unit 152 and the second processing unit 153 in the AI processing unit 15 according to the above-described embodiments will be described.

### 3-5-1. First Example

First, a case where image data is enlarged in the row direction and/or the column direction will be exemplified. Note that processing exemplified below may be executed by the first processing unit 152 or may be executed by the second processing unit 153. In that case, various types of processing such as image recognition processing and smoothing may be applied to the processing executed by the second processing unit 153 or the first processing unit 152 that does not execute the following processing, and the processing may use a neural network or may be rule-based. Hereinafter, for the sake of clarity, a case where the first processing unit 152 executes the processing will be described.

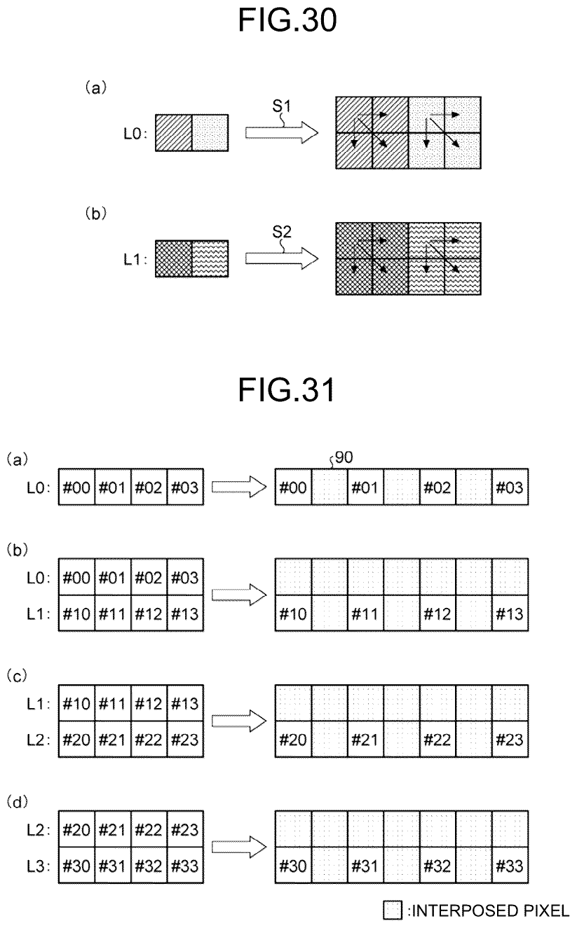

FIG. 30 is a diagram for explaining processing according to a first example. In FIG. 30, (a) illustrates a case where line data of the first line L0 is accumulated in the line memory 14, and (b) illustrates a case where line data of the second line L1 is accumulated in the line memory 14.

In a case where pixel data is multiplied by N (N is an integer of 2 or more) in the row direction and/or the column direction, since the minimum line data necessary for enlargement is one line, the first processing unit 152 can start the processing at a stage where line data for one line is accumulated in the line memory 14. Specifically, as illustrated in (a) of FIG. 30, when line data for one line is accumulated in the line memory 14, the first processing unit 152 generates line data for two lines in which the number of pixels in the row direction is doubled by copying each pixel in the line data one by one in the row direction, the column direction, and a diagonal direction. The generated line data for two lines is sequentially input to the second processing unit 153.

Thereafter, as illustrated in (b) of FIG. 30, every time line data for one line is prepared in the line memory 14, the first processing unit 152 generates line data for two lines in which the number of pixels in the row direction is doubled by copying each pixel in the line data one by one in the row direction, the column direction, and the diagonal direction, and inputs the generated line data for two lines to the second processing unit 153. That is, in this example, the minimum required memory capacity of the line memory 14 is for one line.

In such simple enlargement processing by copying pixels, since the minimum data necessary for the processing is line data for one line, the first processing unit 152 can start the enlargement processing on line data each time the line data for one line is prepared in the line memory 14.

### 3-5-2. Second Example

Next, a case where image data is enlarged by pixel interpolation in the row direction and/or the column direction will be exemplified. Note that processing exemplified below may be executed by any of the first processing unit 152 and the second processing unit 153 as in the first example, and processing executed by the other processing unit may be various types of processing. Hereinafter, for the sake of clarity, a case where the first processing unit 152 executes the processing will be described.

FIG. 31 is a diagram for explaining processing according to a second example. In FIG. 31, (a) illustrates a case where line data of the first line L0 is accumulated in the line memory 14, (b) illustrates a case where line data of the first line L0 and the second line L1 is accumulated in the line memory 14, (c) illustrates a case where line data of the second line L1 and the third line L2 is accumulated in the line memory 14, and (d) illustrates a case where line data of the third line L2 and the fourth line L3 is accumulated in the line memory 14.

Here, various methods are conceivable as an interpolation method in a case where pixel data is enlarged by pixel interpolation in the row direction and/or the column direction, but in the present example, a case where interpolation is performed between pixels adjacent in the row or column direction by using two pixels adjacent in the row or column direction, and interpolation is performed between pixels adjacent in the diagonal direction by using four pixels adjacent in the diagonal direction with respect to a pixel to be interpolated will be exemplified.

In the case of such a method, the minimum line data required for the interpolation processing between pixels constituting line data is one line. Therefore, the first processing unit 152 can start the processing for the line data of the first line L0 at a stage where the line data for one line is accumulated in the line memory 14. Specifically, as illustrated in (a) of FIG. 31, when line data for one line is accumulated in the line memory 14, the first processing unit 152 interpolates pixels 90 between adjacent pixels in the line (in other words, between pixels adjacent in the row direction). For example, a pixel 90 is interpolated between a pixel #00 and a pixel #01 based on the pixel value of the pixel #00 and the pixel value of the pixel #01. Then, the line data of the first row subjected to the interpolation processing is input to the second processing unit 153.

The minimum line data necessary for the interpolation processing between lines is two lines. Therefore, the first processing unit 152 can start the processing on line data of the (n+1)th (n is an integer of 1 or more) line after the second line L1 at a stage where line data for two lines, the nth line and the (n+1) th line, is accumulated in the line memory 14. That is, in this example, the minimum required memory capacity of the line memory 14 is for two lines.

Specifically, as illustrated in (b) to (d) of FIG. 31, when line data of two lines, the nth line and the (n+1)th line, is accumulated in the line memory 14, the first processing unit 152 interpolates pixels 90 between adjacent pixels (in other words, between pixels adjacent in the column direction) between the nth line and the (n+1)th line, interpolates pixels 90 between adjacent pixels in the (n+1)th line, and interpolates pixels 90 between adjacent pixels in the diagonal direction between the nth line and the (n+1)th line. For example, a pixel 90 is interpolated between the pixel #00 and a pixel #10 adjacent between the nth line and the (n+1)th line based on the pixel value of the pixel #00 and the pixel value of the pixel #10, a pixel 90 is interpolated between the pixel #10 and a pixel #11 adjacent in the (n+1)th line based on the pixel value of the pixel #10 and the pixel value of the pixel #11, and a pixel 90 is interpolated between the pixel #00, the pixel #01, the pixel #10, and the pixel #11 adjacent in the diagonal direction between the nth line and the (n+1)th line based on the pixel value of the pixel #00, the pixel value of the pixel #01, the pixel value of the pixel #10, and the pixel value of the pixel #11. Then, the line data for two lines generated by the interpolation processing is sequentially input to the second processing unit 153.

As described above, in the enlargement processing by pixel interpolation, since the minimum data necessary for the processing is line data for two lines, every time the line data for two lines is prepared in the line memory 14 after the second line L1, the first processing unit 152 can start the interpolation processing using the line data for the two lines.

### 3-5-3. Third Example

Next, a case where image data is subjected to deconvolution (also referred to as transposed convolution or up-convolution) processing will be exemplified. Note that processing exemplified below may be executed by any of the first processing unit 152 and the second processing unit 153 similarly to the first example and the second example, and processing executed by the other processing unit may be various types of processing. Hereinafter, for the sake of clarity, a case where the first processing unit 152 executes the processing will be described.

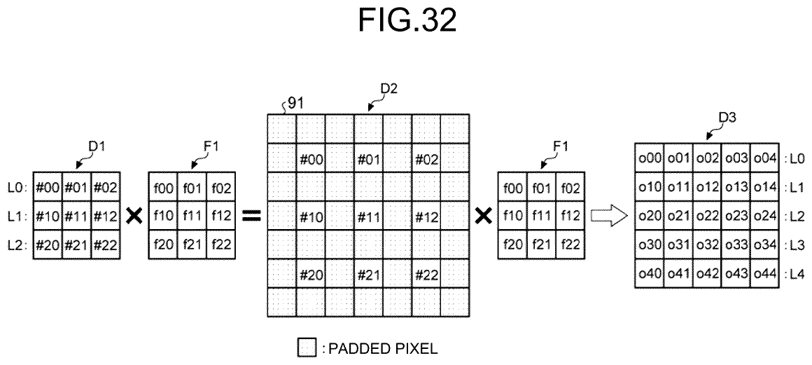

FIG. 32 is a diagram for explaining an outline of the deconvolution processing. As illustrated in FIG. 32, in the deconvolution processing, for example, processing target data D2 is generated by adding pixels 91 having a predetermined pixel value to input data D1 for one frame by padding the pixels 91 around each of the pixels #00 to #22, and output data D3 is generated by performing a convolution operation on the processing target data D2 using a filter F1. Pixel values of the pixels 91 added by the padding may be ‘0’ or a predetermined value of ‘0’ or more. Processing in a case where such deconvolution processing is applied to the present embodiment is as follows.

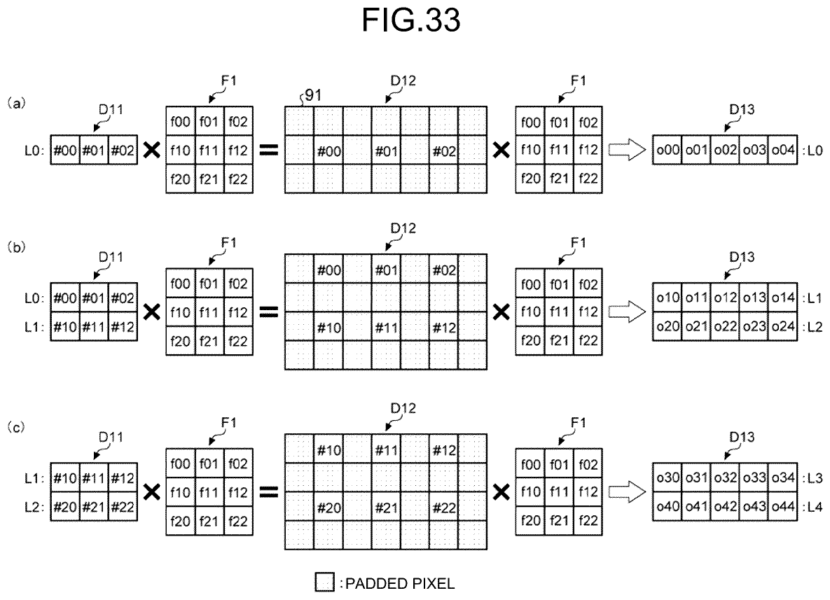

FIG. 33 is a diagram for explaining deconvolution processing according to a third example. In FIG. 33, (a) illustrates a case where line data of the first line L0 is accumulated in the line memory 14, (b) illustrates a case where line data of the first line L0 and the second line L1 is accumulated in the line memory 14, and (c) illustrates a case where line data of the second line L1 and the third line L2 is accumulated in the line memory 14. In the following description, a case where a filter f1 has three rows and three columns will be exemplified.

As illustrated in (a) of FIG. 33, in the deconvolution processing, when line data D11 of the first line L0 is accumulated in the line memory 14, the first processing unit 152 generates processing target data (processing target data of three rows and K columns (K is an integer of 2 or more) in this example) D12 of the same number of rows as the number of rows (3 rows in this example) of the filter f1 by padding the periphery of each of pixels #00 to #02 of the line data D11 with pixels 91. Then, the first processing unit 152 performs a convolution operation on the processing target data D12 using the filter f1 to generate output data D13 of the first line L0.

Next, as illustrated in (b) of FIG. 33, when line data of the second line is accumulated in the line memory 14, the first processing unit 152 generates processing target data (processing target data of 4 rows and K columns in this example) D12 of the number of rows (4 rows) larger by one line than the number of rows (3 rows) of the filter f1 by padding the periphery #10 to #12 of each pixel of the line data of the second line with pixels 91 and padding between the pixels #00 to #02 of the line data of the first line. Then, the first processing unit 152 performs a convolution operation on the processing target data D12 using the filter f1 to generate output data D13 of the second line L1 and the third line L2. That is, in this example, the minimum required memory capacity of the line memory 14 is for two lines.

Thereafter, similarly (see, for example, (c) of FIG. 33), when line data of the (n+1)th line is accumulated in the line memory 14, the first processing unit 152 generates processing target data D12 of the number of rows (4 rows) larger by one line than the number of rows (3 rows) of the filter f1 by padding the periphery of each pixel of the line data of the (n+1)th line with pixels 91 and padding between pixels of the line data of the nth line, and generates output data D13 of two lines by performing a convolution operation on the processing target data D12 using the filter f1.

As described above, in the deconvolution processing, since the minimum data required for the processing is line data for two lines, every time line data for two lines is prepared in the line memory 14 after the second line L1, the first processing unit 152 can start the deconvolution processing using these two line data.

### 3-5-4. Fourth Example

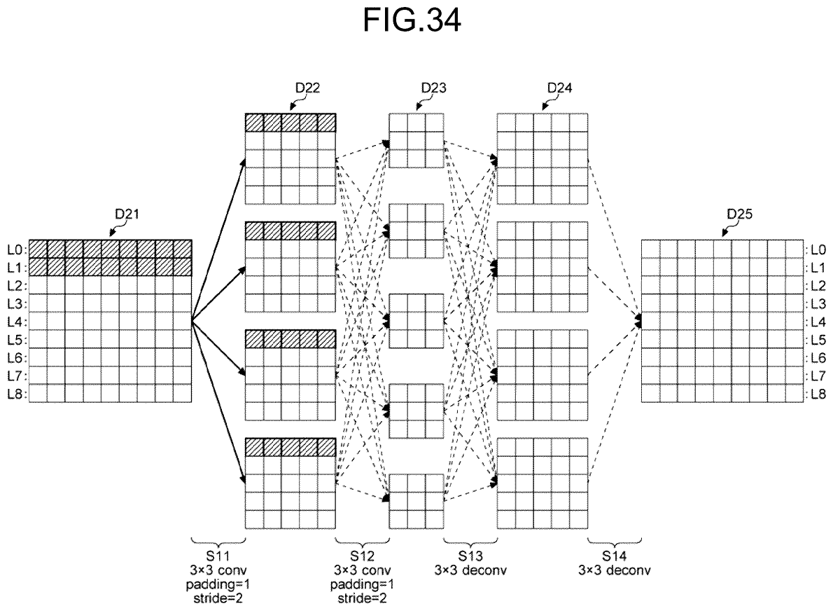

Next, a case where an auto encoder is implemented by the AI processing unit 15 of the above-described embodiments will be exemplified. FIGS. 34 to 38 are diagrams for explaining an operation of the auto encoder implemented by the AI processing unit in a fourth example.

In the following description, the size of input data D21 is 9×9, the size of the filter f1 is 3×3, and a stride is 2. The stride is a movement width (also referred to as an application interval) of a window in the convolution processing. Therefore, in this example in which the stride is 2, the processing is executed every two lines.

In the following description, a case where steps S11 and S12 are two-stage convolution processing, and steps S13 and S14 are two-stage deconvolution processing will be exemplified. Further, the two-stage convolution processing in steps S11 and S12 may be executed by the first processing unit 152, for example, and the two-stage deconvolution processing in steps S13 and S14 may be executed by the second processing unit 153, for example. However, the present invention is not limited thereto, and all of steps S11 to S14 may be executed by the first processing unit 152 or the second processing unit 153.

### (First Stage)

### Step S11

In a case where the AI processing unit 15 operates as the auto encoder, first, as illustrated in FIG. 34, when the input data D21 for two lines (L0, L1) is accumulated in the line memory 14, pixels of a predetermined value are padded pixel by pixel so as to surround the periphery of the input data D21 in four directions in a case where it is assumed that the input data D21 for all lines are prepared. In the present example, since the padding is for the line data of the first line L0 and the line data of the second line L1 located at the end of the input data D21, one pixel at each end of each of the line data of the first line L0 and the line data of the second line L1, and a pixel column for one line (including pixels padded at the end of each line data) on the opposite side to the line data of the second line L1 across the line data of the first line L0 are added by padding. The predetermined value may be zero or a nonzero predetermined value.

Subsequently, since the input data D21 for substantially three lines are prepared by padding, the convolution operation using the 3×3 filter f1 is executed on the input data D21 for three lines (step S11). As a result, first intermediate data D22 for one line is generated.

At this stage, since the first intermediate data D22 corresponds to only one line and does not correspond to three lines necessary for the convolution operation using the 3×3 filter f1 even if padding for one line is performed, the input of the input data D21 for the next line is waited.

### (Second Stage)

### Step S11

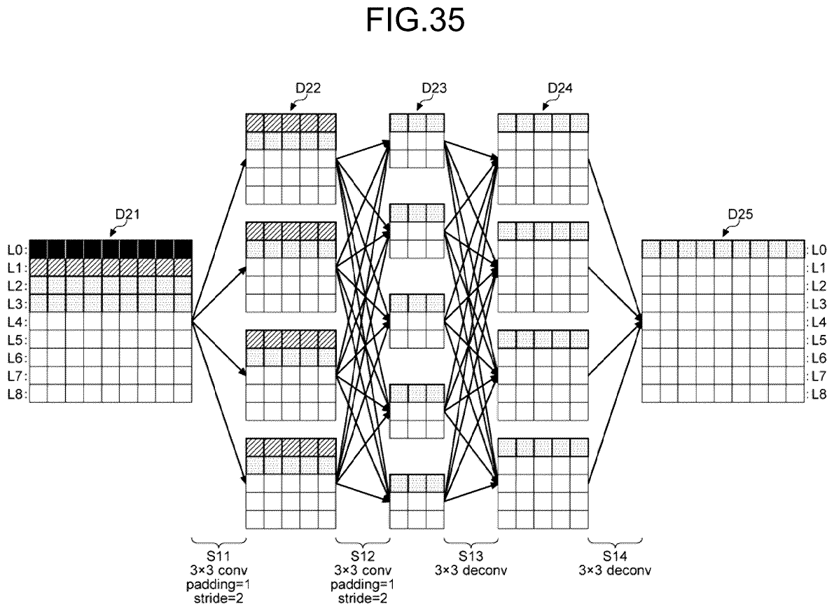

Next, as illustrated in FIG. 35, when line data for a stride (for 2 lines in this example) (L2, L3) is newly input, line data for 3 lines necessary for the convolution operation using the 3×3 filter f1 is accumulated in the line memory 14. In this example, line data for three lines, the line data of the second line L1 among the line data of the first line L0 and the second line L1 stocked in the line memory 14 and the newly input line data of the third line L2 and the fourth line L3, are stocked in the line memory 14. That is, in this example, the minimum memory capacity required for the line memory 14 arranged in the input layer is for 3 lines.

Subsequently, similarly to the first stage, pixels are padded pixel by pixel at positions surrounding the entire input data D21. In this example, since the padding is for the line data of the second line L1 to the fourth line L3 not located at the end of the input data D21, one pixel is padded at each end of the line data of the second line L1 to the fourth line L3.

Subsequently, a convolution operation using the 3×3 filter f1 is performed on the input data D21 of the padded three lines (step S11). As a result, the first intermediate data D22 for one line is added, and the first intermediate data D22 for two lines is stocked in the line memory.

### Step S12

When the first intermediate data D22 for two lines is stocked, pixels of a predetermined value are padded pixel by pixel so as to surround the periphery of the first intermediate data D22 in four directions in a case where it is assumed that first intermediate data D22 for all lines is prepared. In the present example, similarly to the padding for the input data D21 in the first stage, since the padding is for the line data of the first line and the line data of the second line located at the end of the first intermediate data D22, one pixel at each end of each of the line data of the first line and the line data of the second line and a pixel column (including pixels padded at the end of each line data) for one line on the opposite side of the line data of the second line across the line data of the first line are added by padding. The predetermined value may be zero or a nonzero predetermined value.

Subsequently, since the first intermediate data D22 for substantially three lines is prepared by padding, the convolution operation using the 3×3 filter f1 is executed on the first intermediate data D22 for three lines (step S12). As a result, second intermediate data D23 for one line is generated.

### Step S13

Subsequently, deconvolution processing is executed on the generated second intermediate data D23. Specifically, similarly to the deconvolution processing on the line data of the first line L0 described above with reference to (a) of FIG. 33, pixels having a predetermined value are padded around each pixel in the second intermediate data D23 of the first line, and the convolution operation using the 3×3 filter f1 is executed on the second intermediate data D23 corresponding to three lines by the padding (step S13). As a result, third intermediate data D24 for one line is generated.

### Step S14

Subsequently, deconvolution processing is executed on the generated third intermediate data D24. Specifically, similarly to step S13, pixels having a predetermined value are padded around each pixel in the third intermediate data D24 of the first line, and the convolution operation using the 3×3 filter f1 is executed on the third intermediate data D24 for three lines by the padding (step S14). As a result, output data D25 of the first line L0 is generated.

### (Third Stage)

### Step S11

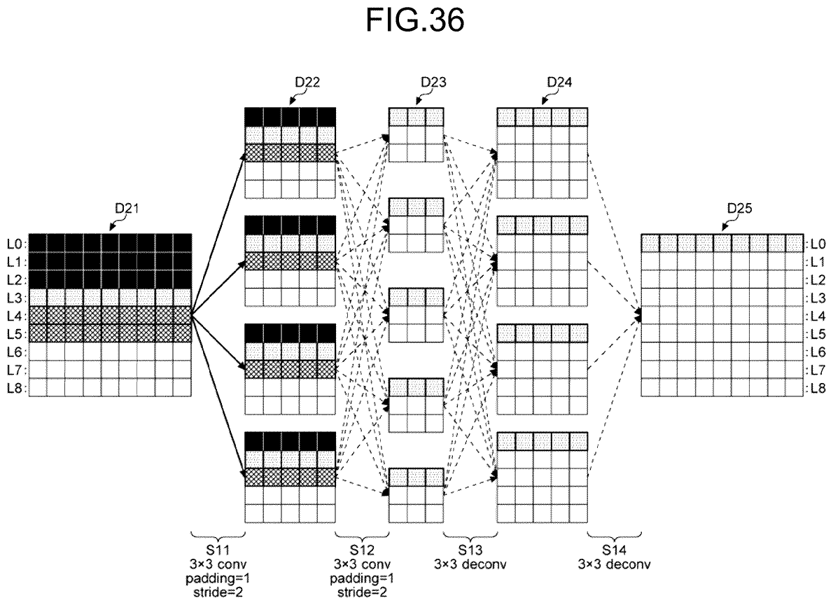

Next, as illustrated in FIG. 36, when line data for a stride (for 2 lines in this example) (L4, L5) is newly input, line data for 3 lines necessary for the convolution operation using the 3×3 filter f1 is accumulated in the line memory 14. In this example, line data for three lines, the line data of the fourth line L3 among the line data of the second to fourth lines L1 to L3 stocked in the line memory 14 and the newly input line data of the fifth line L4 and the sixth line L5, are stocked in the line memory 14.

Subsequently, similarly to the second stage, pixels are padded pixel by pixel at positions surrounding the entire input data D21. In this example, since the padding is for the line data of the fourth line L3 to the sixth line L5 not located at the end of the input data D21, one pixel is padded at each end of the line data of the fourth line L3 to the sixth line L5.

Subsequently, a convolution operation using the 3×3 filter f1 is performed on the input data D21 of the padded three lines (step S11). As a result, the first intermediate data D22 for one line is added.

Hitherto, the first intermediate data D22 output in step S11 corresponds to three lines, but since the first intermediate data D22 of the first line has been used, the first intermediate data D22 to be processed corresponds to two lines of the second line and the third line. Therefore, since the number of lines is less than 3 lines necessary for the convolution operation using the 3×3 filter f1, the input of the input data D21 for the next line is waited.

### (Fourth Stage)

### Step S11

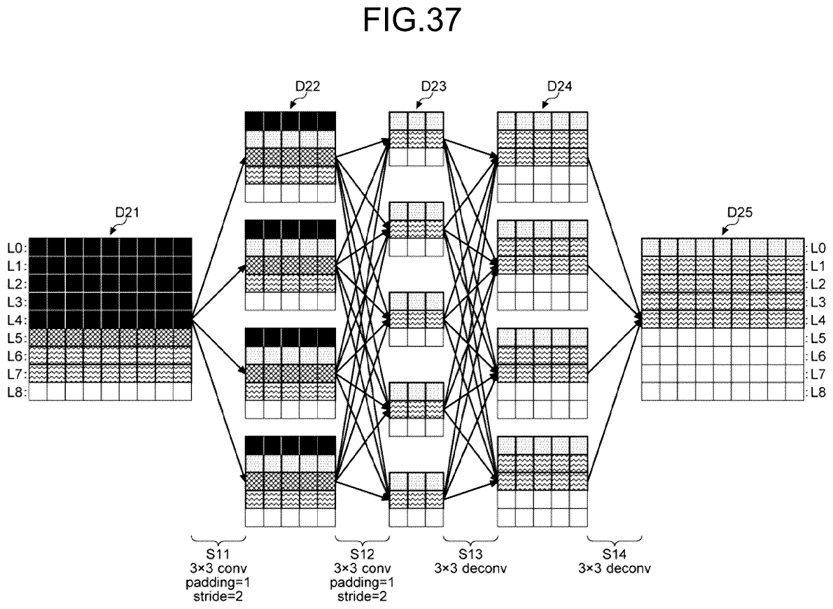

Next, as illustrated in FIG. 37, when line data for a stride (for 2 lines in this example) (L6, L7) is newly input, line data for 3 lines necessary for the convolution operation using the 3×3 filter f1 is accumulated in the line memory 14. In this example, line data for three lines, the line data of the sixth line L5 among the line data of the fourth to sixth lines L3 to L5 stocked in the line memory 14 and the newly input line data of the seventh line L6 and the eighth line L7, are stocked in the line memory 14.

Subsequently, similarly to the second stage, pixels are padded pixel by pixel at positions surrounding the entire input data D21. In this example, since the padding is for the line data of the sixth line L5 to the eighth line L7 not located at the end of the input data D21, one pixel is padded at each end of the line data of the sixth line L5 to the eighth line L7.

Subsequently, a convolution operation using the 3×3 filter f1 is performed on the input data D21 of the padded three lines (step S11). As a result, the first intermediate data D22 for one line is added, and the first intermediate data D22 for three lines is stocked in the line memory.

### Step S12

When the first intermediate data D22 for three lines are stocked, similarly to the second stage, pixels of a predetermined value are padded pixel by pixel so as to surround the periphery of the first intermediate data D22 in the four directions in a case where it is assumed that the first intermediate data D22 for all lines are prepared. In this example, since the padding is for the line data of the second to fourth lines not located at the end of the first intermediate data D22, one pixel is padded at each end of each of the line data of the second to fourth lines.

Subsequently, a convolution operation using the 3×3 filter f1 is performed on the first intermediate data D22 for the padded 3 lines (step S12). As a result, the second intermediate data D23 for one line is added, and the second intermediate data D23 for two lines is stocked in the line memory.

### Step S13

Subsequently, the deconvolution processing is performed on the second intermediate data D23 for two lines stocked in the line memory. Specifically, similarly to the deconvolution processing for the line data of the first line L0 and the second line L1 described above with reference to (b) of FIG. 33, pixels having a predetermined value are padded around each pixel in the second intermediate data D23 of the first line and the second line, and the convolution operation using the 3×3 filter f1 is executed on the second intermediate data D23 for three lines by the padding (step S13). As a result, third intermediate data D24 for two line is generated.

### Step S14

Subsequently, deconvolution processing is executed on the newly generated third intermediate data D24 for two lines. Specifically, similarly to the deconvolution processing for the line data of the first line L0 and the second line L1 and the line data of the second line L1 and the third line L2 described above with reference to (b) and (c) of FIG. 33, pixels having a predetermined value are appropriately padded around each pixel in each line of the second intermediate data D23, and the convolution operation using the 3×3 filter f1 is executed on the second intermediate data D23 for three lines by the padding (step S14). As a result, output data D25 for four lines from the second line L1 to the fifth line L4 is generated.

### (Fifth Stage)

### Step S11

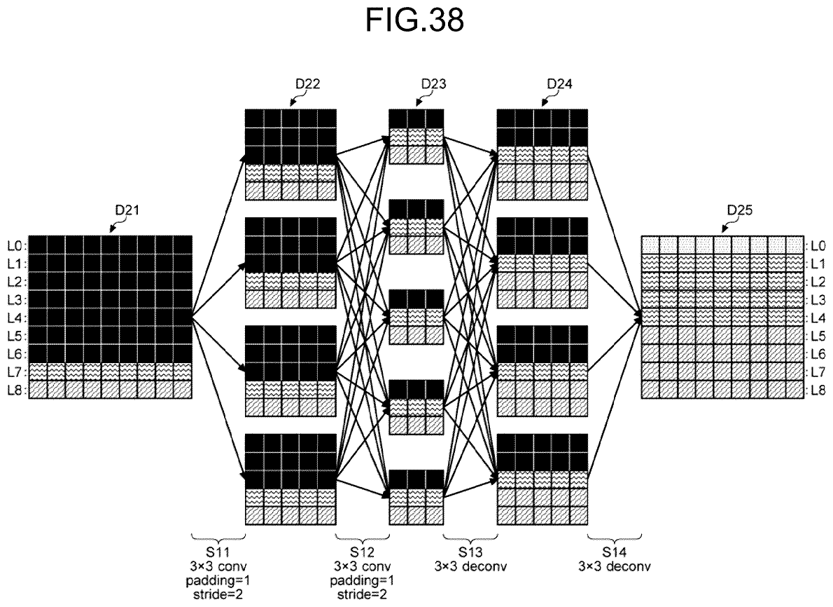

Next, as illustrated in FIG. 38, when line data for the remaining line (L8) is newly input, line data for two lines is accumulated in the line memory 14. In this example, line data for two lines, the line data of the eighth line L7 among the line data of the sixth line L5 to the eighth line L7 stocked in the line memory 14 and the newly input line data of the ninth line L8, are stocked in the line memory 14.

Subsequently, similarly to the first stage, pixels are padded pixel by pixel at positions surrounding the entire input data D21. In the present example, since the line data of the ninth line L8 located at the end of the input data D21 is included, one pixel at each end of the line data of the eighth line L7 and the ninth line L8, and a pixel column (including pixels padded at the end of each line data) for one line on the opposite side of the line data of the eighth line L7 across the line data of the ninth line L8 are added by padding.

Subsequently, since the input data D21 for substantially three lines are prepared by padding, the convolution operation using the 3×3 filter f1 is executed on the input data D21 for three lines (step S11). As a result, the first intermediate data D22 for one line is added, and the first intermediate data D22 for two lines is stocked in the line memory.

### Step S12

When the first intermediate data D22 for two lines is stocked, similarly to the second stage, pixels of a predetermined value are padded pixel by pixel so as to surround the periphery of the first intermediate data D22 in the four directions in a case where it is assumed that the first intermediate data D22 for all lines is prepared. In this example, since the line data of the fifth line located at the end of the first intermediate data D22 is included, one pixel at each end of the line data of the fourth line and the fifth line by padding, and a pixel column (including pixels padded at the end of each line data) of one line on the opposite side of the line data of the fourth line across the line data of the fifth line are added by padding.

Subsequently, since the first intermediate data D22 for three lines for substantially three lines is prepared by padding, the convolution operation using the 3×3 filter f1 is executed on the first intermediate data D22 for three lines (step S12). As a result, the second intermediate data D23 for one line is added, and the second intermediate data D23 for two lines is stocked in the line memory.

### Step S13

Subsequently, the deconvolution processing is performed on the second intermediate data D23 for two lines stocked in the line memory. Specifically, similarly to step S13 in the fourth stage, pixels of a predetermined value are padded around each pixel in the second intermediate data D23 of the second line and the third line, and the convolution operation using the 3×3 filter f1 is executed on the second intermediate data D23 for three lines by the padding (step S13). As a result, third intermediate data D24 for two line is generated.

### Step S14

Subsequently, deconvolution processing is executed on the newly generated third intermediate data D24 for two lines. Specifically, similarly to step S14 in the fourth stage, pixels having a predetermined value are appropriately padded around each pixel in each line of the second intermediate data D23, and the convolution operation using the 3×3 filter f1 is executed on the second intermediate data D23 for 3 lines by the padding (step S14). As a result, output data D25 for four lines from the sixth line L5 to the ninth line L8 is generated. As a result, all the output data D25 from the first line L0 to the ninth line L8 are prepared.

As described above, even in a case where the AI processing unit 15 functions as the auto encoder, the memory capacity required for the output of each layer can be greatly reduced. In addition, after the third line L2, the processing can be started each time line data for a stride (for two lines in this example) is prepared in the line memory 14.

Note that the effects described in the present specification are merely examples and are not limited, and other effects may be provided.

Note that the present technology can also include the following configurations.

(1)

An imaging device including:
a sensor that captures an image for one frame by a pixel region in which a plurality of pixels is arranged;
a first processing unit that executes convolution processing in a predetermined line unit read from the pixel region instead of an image unit for the one frame, and executes feature amount extraction processing based on a result of executing the convolution processing; and a second processing unit that executes full-connection processing based on a result of the feature extraction processing and outputs an inference result based on a result of the full-connection processing.
   (2)

The imaging device described in (1), wherein
the predetermined line unit is a line unit corresponding to the number of rows of a filter used in the convolution processing, and
the imaging device further includes a line memory that stores pixels of a line corresponding to the number of rows of the filter as data of an execution unit of the convolution processing, and the first processing unit executes the convolution processing every time data of the execution unit of the convolution processing is stored in the line memory.
   (3)

The imaging device described in (2), wherein
the line memory stores pixels of a line corresponding to the number of rows of the filter in order from a reading start position of the pixel region, and pixels of a line of the pixel region processed by the first processing unit are updated with pixels of a line newly read from the pixel region to store data of the execution unit of the convolution processing.
   (4)

The imaging device described in (1), wherein the predetermined line unit is one line unit of the pixel region.

(5)

The imaging device described in (1), wherein the sensor captures the image by a rolling shutter system.

(6)

The imaging device described in (1), wherein the sensor captures the image by a global shutter system.

(7)

An imaging method including:
a step of capturing an image for one frame by a pixel region in which a plurality of pixels is arranged;
a step of executing convolution processing in a predetermined line unit read from the pixel region instead of an image unit for the one frame, and executing feature amount extraction processing based on a result of executing the convolution processing; and
a step of executing full-connection processing based on a result of the feature extraction processing and outputting an inference result based on a result of the full-connection processing.
   (8)

An imaging program for causing a computer including a sensor that captures an image for one frame by a pixel region in which a plurality of pixels is arranged to function as:
a first processing unit that executes convolution processing in a predetermined line unit read from the pixel region instead of an image unit for the one frame, and executes feature amount extraction processing based on a result of executing the convolution processing; and
a second processing unit that executes full-connection processing based on a result of the feature extraction processing and outputs an inference result based on a result of the full-connection processing.
   (9)

An imaging device including:
a sensor that outputs first image data;
a first processing unit that executes processing of a first layer in a neural network having a layered structure on the first image data in units of second image data having a size smaller than an entire size of the first image data; and
a second processing unit that executes processing of a second layer in the neural network on a processing result output from the first processing unit.
   (10)

The imaging device described in (9), wherein the second image data is image data for a predetermined number of lines in the first image data.

(11)

The imaging device described in (9) or (10), wherein the processing of the first layer includes convolution processing.

(12)

The imaging device described in (11), wherein the second image data is image data for the number of lines corresponding to the number of rows of a filter used in the convolution processing.

(13)

The imaging device described in (12), further including
a line memory for the number of lines corresponding to the number of rows of the filter,
the sensor sequentially reads the first image data in units of lines and inputs the first image data to the line memory, and
the first processing unit executes the processing of the first layer on the second image data stored in the line memory.
   (14)

The imaging device described in any one of (11) to (13), wherein the processing of the second layer includes full-connection processing.

(15)

The imaging device described in any one of (11) to (13), wherein the processing of the second layer includes deconvolution processing.

(16)

The imaging device described in any one of (9) to (15), wherein at least one of the processing of the first layer and the processing of the second layer includes enlargement processing of enlarging the second image data.

(17)

The imaging device described in any one of (1) to (16), wherein at least one of the processing of the first layer and the processing of the second layer includes interpolation processing of interpolating between pixels in the second image data.

(18)

The imaging device described in any one of (9) to (17), wherein the sensor, the first processing unit, and the second processing unit are mounted on a single chip.

(19)

The imaging device described in (18), wherein
the single chip is a stacked chip, and
the sensor is disposed in a first layer in the stacked chip, and
at least one of the first processing unit and the second processing unit is disposed in a second layer in the stacked chip.
   (20)

An imaging device including:
a sensor that outputs image data in units of lines;
a first processing unit that executes first processing that is a part of predetermined processing on data of a predetermined number of lines output from the sensor; and
a second processing unit that executes second processing that is at least a remaining part of the predetermined processing on a processing result output from the first processing unit, wherein
the first processing unit executes the first processing each time data of the predetermined number of lines is output from the sensor, and
the second processing unit executes the second processing each time a processing result is output from the first processing unit.
   (21)

The imaging device described in (20), wherein the predetermined processing is recognition processing for the image data.

(22)

The imaging device described in (20) or (21), wherein the predetermined number of lines is the same as the number of rows in a processing unit of the first processing.

(23)

An imaging method executed by a processor mounted on an imaging device, the imaging method including:
executing processing of a first layer in a neural network having a layered structure on first image data output from a sensor in units of second image data having a size smaller than an entire size of the first image data;
executing processing of a second layer in the neural network on a result of the processing of the first layer.
   (24)

An imaging program for causing a processor mounted on an imaging device to function to execute:
processing of a first layer in a neural network having a layered structure on first image data output from a sensor in units of second image data having a size smaller than an entire size of the first image data; and
processing of a second layer in the neural network on a result of the processing of the first layer.

Reference Signs List

| | |
|---|---|
| 1 | IMAGING DEVICE |
| 2a, 2b | SOLID-STATE IMAGING ELEMENT |
| 11 | SENSOR |
| 12 | SENSOR CONTROL UNIT |
| 13 | DATA PROCESSING UNIT |
| 14 | LINE MEMORY |
| 15 | AI PROCESSING UNIT |
| 16 | PARAMETER MEMORY |
| 20a | PIXEL UNIT |
| 20b | MEMORY + LOGIC UNIT |
| 20b′ | LOGIC UNIT |
| 20c | MEMORY UNIT |
| 30, 31 | NETWORK |
| 151 | CONTROL UNIT |
| 152 | FIRST PROCESSING UNIT |
| 153 | SECOND PROCESSING UNIT |

1. An imaging device including:
a sensor that outputs first image data;
a first processing unit that executes processing of a first layer in a neural network having a layered structure on the first image data in units of second image data having a size smaller than an entire size of the first image data; and
a second processing unit that executes processing of a second layer in the neural network on a processing result output from the first processing unit.

2. The imaging device according to claim 1, wherein the second image data is image data for a predetermined number of lines in the first image data.

3. The imaging device according to claim 1, wherein the processing of the first layer includes convolution processing.

4. The imaging device according to claim 3, wherein
the second image data is image data for the number of lines corresponding to the number of rows of a filter used in the convolution processing.

5. The imaging device according to claim 4, further including
a line memory for the number of lines corresponding to the number of rows of the filter,
the sensor sequentially reads the first image data in units of lines and inputs the first image data to the line memory, and
the first processing unit executes the processing of the first layer on the second image data stored in the line memory.

6. The imaging device according to claim 3, wherein
the processing of the second layer includes full-connection processing.

7. The imaging device according to claim 3, wherein
the processing of the second layer includes deconvolution processing.

8. The imaging device according to claim 1, wherein
at least one of the processing of the first layer and the processing of the second layer includes enlargement processing of enlarging the second image data.

9. The imaging device according to claim 1, wherein
at least one of the processing of the first layer and the processing of the second layer includes interpolation processing of interpolating between pixels in the second image data.

10. The imaging device according to claim 1, wherein
the sensor, the first processing unit, and the second processing unit are mounted on a single chip.

11. The imaging device according to claim 10, wherein
the single chip is a stacked chip, and
the sensor is disposed in a first layer in the stacked chip, and
at least one of the first processing unit and the second processing unit is disposed in a second layer in the stacked chip.

12. An imaging device including:
a sensor that outputs image data in units of lines;
a first processing unit that executes first processing that is a part of predetermined processing on data of a predetermined number of lines output from the sensor; and
a second processing unit that executes second processing that is at least a remaining part of the predetermined processing on a processing result output from the first processing unit, wherein
the first processing unit executes the first processing each time data of the predetermined number of lines is output from the sensor, and
the second processing unit executes the second processing each time a processing result is output from the first processing unit.

13. The imaging device according to claim 12, wherein
the predetermined processing is recognition processing for the image data.

14. The imaging device according to claim 12, wherein
the predetermined number of lines is the same as the number of rows in a processing unit of the first processing.

15. An imaging method executed by a processor mounted on an imaging device, the imaging method including:
executing processing of a first layer in a neural network having a layered structure on first image data output from a sensor in units of second image data having a size smaller than an entire size of the first image data;
executing processing of a second layer in the neural network on a result of the processing of the first layer.

16. An imaging program for causing a processor mounted on an imaging device to function to execute:
processing of a first layer in a neural network having a layered structure on first image data output from a sensor in units of second image data having a size smaller than an entire size of the first image data; and
processing of a second layer in the neural network on a result of the processing of the first layer.
